(19) United States
(12) Patent Application Publication
(10) Pub. No.: US 2025/0251539 A1
(43) Pub. Date: Aug. 7, 2025

(54) POLARIZING FILMS AND MANUFACTURING METHODS THEREOF, OPTICAL WAVEGUIDE LENSES, AND DISPLAY DEVICES

(71) Applicants: SVG TECH GROUP CO., LTD., Suzhou (CN); SOOCHOW UNIVERSITY, Suzhou (CN)

(72) Inventors: Minghui LUO, Suzhou (CN); Zhen ZHOU, Suzhou (CN); Wen QIAO, Suzhou (CN); Linsen CHEN, Suzhou (CN)

(73) Assignees: SVG TECH GROUP CO., LTD., Suzhou (CN); SOOCHOW UNIVERSITY, Suzhou (CN)

(21) Appl. No.: 19/091,904

(22) Filed: Mar. 27, 2025

Related U.S. Application Data
(63) Continuation-in-part of application No. PCT/CN2023/077338, filed on Feb. 21, 2023.

(30) Foreign Application Priority Data
Sep. 27, 2022 (CN) 202211181357.5

(51) Int. Cl. G02B 5/30; G02B 1/14; G02B 5/18; G02B 6/125; G02B 6/126

(52) U.S. Cl. CPC G02B 5/30; G02B 1/14; G02B 5/1857; G02B 5/1866; G02B 6/125; G02B 6/126

(57) ABSTRACT

Disclosed is a polarizing film and a manufacturing method thereof, an optical waveguide lens, and a display device. The polarizing film comprises a transparent substrate; a dielectric grating disposed on the transparent substrate and provided with ridges and grooves which are periodically arrange at intervals; and a metallic layer configured to cover a top surface and a side surface of each of the ridges of the dielectric grating to cause at least a portion of a bottom of each of the grooves of the dielectric grating to be exposed. According to the polarizing film with a novel structure, by the optimized structural design of the dielectric grating and the metallic layer, the optical properties of the low absorption loss, the high extinction ratio, and the wide incident angle can be realized, which is conducive to wide application.

### CROSS-REFERENCE TO RELATED APPLICATIONS

This application is a Continuation-in-part of International Application No. PCT/CN2023/077338, filed on Feb. 21, 2023, which claims priority to Chinese Application No. 202211181357.5, filed on Sep. 27, 2022, the entire contents of each of which are incorporated herein by reference.

### TECHNICAL FIELD

The present disclosure relates to the field of display technology, and in particular to a polarizing film and a manufacturing method thereof, an optical waveguide lens, and a display device.

### BACKGROUND

A polarizing film is an important optical component for display devices requiring high contrast polarization, such as a miniature projector, a polarizing beam splitter, a head-up display, etc., where a high extinction ratio, a wide range of incident angle, and a very compact size are required. The polarizing film is widely used in the polarizing beam splitter because of the ability to efficiently transmit a desired polarization state while reflecting an unwanted state, and maintain spectrally flat at an incident angle up to 45°. In addition, the polarizing film based on a metal grid performs well in a high temperature or high humidity environment, while providing excellent polarization beam splitting performance in a visible and near-infrared spectral range from 400 nm to 1200 nm.

However, conventional polarizing films are unable to combine optical properties such as low absorption loss, high extinction ratio, and wide incident angle, which is not conducive to wide application.

Therefore, it is desirable to provide a polarizing film and a manufacturing method thereof, an optical waveguide lens, and a display device that can simultaneously achieve the optical properties of low absorption loss, high extinction ratio, and wide incident range.

### SUMMARY

One or more embodiments of the present disclosure provide a polarizing film. The polarizing film may comprise a transparent substrate; a dielectric grating disposed on the transparent substrate and provided with ridges and grooves which are periodically arrange at intervals; and a metallic layer configured to cover a top surface and a side surface of each of the ridges of the dielectric grating to cause at least a portion of a bottom of each of the grooves of the dielectric grating to be exposed.

In some embodiments, a period of the dielectric grating may be in a range of 50 nm-150 nm, a duty ratio of the dielectric grating may be in a range of 0.1-0.5, a thickness of each of the ridges of the dielectric grating may be in a range of 30 nm-110 nm, a thickness of a portion of the metallic layer located on the top surface of each of the ridges of the dielectric grating may be in a range of 30 nm-150 nm, and a thickness of a portion of the metallic layer located on the side surface of each of the ridges of the dielectric grating may be in a range of 5 nm-50 nm.

In some embodiments, a refractive index of the transparent substrate may be in a range of 1.3-1.9, and a refractive index of the dielectric grating may be in a range of 1.3-1.7.

In some embodiments, a width of a portion of the metallic layer located on the bottom of each of the grooves of the dielectric grating may be in a range of 0 nm-50 nm, and a thickness of the portion of the metallic layer located on the bottom of each of the grooves of the dielectric grating may be in a range of 0 nm-50 nm.

In some embodiments, the bottom of each of the grooves of the dielectric grating may be completely exposed out of the metallic layer.

In some embodiments, a material of the metallic layer may be at least one of gold, silver, copper, aluminum, and tungsten.

In some embodiments, a material of the dielectric grating may be a resin-based curing adhesive.

In some embodiments, the transparent substrate may be a flexible substrate.

In some embodiments, a material of the flexible substrate may be at least one of polycarbonate, polyvinyl chloride, polyethylene terephthalate, polymethylmethacrylate, polypropylene, and cellulose triacetate.

In some embodiments, the polarizing film may further include a protective layer. The protective layer may cover the transparent substrate, the dielectric grating, and the metallic layer.

In some embodiments, a refractive index of the protective layer may be in a range of 1.3-1.7, and a distance between a surface of the protective layer away from the transparent substrate and the metallic layer may be in a range of 0 nm-300 nm.

In some embodiments, a material of the protective layer may be at least one of SiO₂, MgF₂, and SiON.

One or more embodiments of the present disclosure provide a manufacturing method of a polarizing film. The manufacturing method may comprise: forming a dielectric grating on a transparent substrate, the dielectric grating being provided with ridges and grooves which are periodically arranged at intervals; and forming a metallic layer on the dielectric grating, the metallic layer being configured to cover a top surface and a side surface of each of the ridges of the dielectric grating to cause at least a portion of a bottom of each of the grooves of the dielectric grating to be exposed, so as to obtain the polarizing film.

In some embodiments, forming a dielectric grating on a transparent substrate may include: attaching the transparent substrate to an imprinting template, an imprinting adhesive being coated between the transparent substrate and the imprinting template, then pressing the transparent substrate and the imprinting template, and demolding the imprinting template from the imprinting adhesive after the imprinting adhesive is cured to form the dielectric grating on the transparent substrate.

In some embodiments, the forming a metallic layer on the dielectric grating may include: forming the metallic layer on the dielectric grating by a plating process, wherein aluminum (Al) is plated, a plating thickness is in a range of 5 nm-200 nm, a plating rate is in a range of 0.1 Å/S-10 Å/S, an evaporation power is in a range of 0-60%, an operation vacuum level is in a range of 1E-6 Torr-10E-6 Torr, and a temperature is in a range of 25° C.-35° C.

One or more embodiments of the present disclosure provide an optical waveguide lens. The optical waveguide lens may comprise: an optical waveguide provided with a light receiving surface for receiving light and a backlight surface disposed on an opposite side of the light receiving surface; and the polarizing film described above disposed on the backlight surface of the optical waveguide, the transparent substrate of the polarizing film being disposed away from the optical waveguide. A gap may be provided between the optical waveguide and the polarizing film.

In some embodiments, a transmittance of the polarizing film for S-polarized light may be less than 5%, and a transmittance of the polarizing film to P-polarized light may be greater than or equal to 60%. The polarizing film may be fixed to the optical waveguide through a bonding adhesive. The bonding adhesive may be disposed at an edge position of the polarizing film and the optical waveguide.

In some embodiments, a distance between the optical waveguide and the polarizing film may be in a range of 1 μm-5 cm.

In some embodiments, the optical waveguide lens may further include a rigid substrate configured to support the polarizing film. The rigid substrate may fit a side of the polarizing film away from the optical waveguide.

After experiments, it is verified that the polarizing film can realize the optical properties of lower absorption loss, higher extinction ratio, and wider incident angle, thereby improving the performance of the display device and the optical waveguide lens adopting the polarizing film, and facilitating wide application to the display device and the optical waveguide lens.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic diagram illustrating optical properties of a polarizing film according to some embodiments of the present disclosure;

FIG. 2 is a schematic structural diagram illustrating a polarizing film according to some embodiments of the present disclosure;

FIG. 3 is a schematic structural diagram illustrating a polarizing film according to other embodiments of the present disclosure;

FIG. 4 is a flowchart illustrating a manufacturing method of a polarizing film according to some embodiments of the present disclosure;

FIG. 5 is a schematic diagram illustrating an overall optical waveguide lens according to some embodiments of the present disclosure;

FIG. 6 is a schematic diagram illustrating light of an optical waveguide lens according to some embodiments of the present disclosure;

FIG. 7 is transmittance spectrograms illustrating a polarizing film at normal incidence of P-polarized light and S-polarized light according to Example 1 of the present disclosure;

FIG. 8 is reflectance spectrograms illustrating P-polarized light and S-polarized light of a polarizing film according to Example 1 of the present disclosure;

FIG. 9 is transmittance spectrograms illustrating a polarizing film at different incident angles of P-polarized light and S-polarized light according to Example 1 of the present disclosure;

FIG. 10 is reflectance spectrograms illustrating a polarizing film at different incident angles of P-polarized light and S-polarized light according to Example 1 of the present disclosure;

FIG. 11 is transmittance spectrograms illustrating a polarizing film at a 0° incident angle of P-polarized light and S-polarized light in a visible wavelength range according to Examples 1-5 of the present disclosure;

FIG. 12 is transmittance spectrograms illustrating a polarizing film at a 0° incident angle of P-polarized light and S-polarized light in a visible wavelength range according to Examples 6-9 of the present disclosure;

FIG. 13 is transmittance spectrograms illustrating a polarizing film at a 0° incident angle of P-polarized light and S-polarized light in a visible wavelength range according to Examples 10-13 of the present disclosure;

FIG. 14 is transmittance spectrograms illustrating a polarizing film at a 0° incident angle of P-polarized light and S-polarized light in a visible wavelength range according to Examples 14-17 of the present disclosure;

FIG. 15 is transmittance spectrograms illustrating a polarizing film at normal incidence of P-polarized light and S-polarized light according to Example 14 of the present disclosure;

FIG. 16 is transmittance spectrograms illustrating a polarizing film at normal incidence of P-polarized light and S-polarized light according to Example 15 of the present disclosure;

FIG. 17 is transmittance spectrograms illustrating a polarizing film at normal incidence of P-polarized light and S-polarized light according to Example 16 of the present disclosure;

FIG. 18 is transmittance spectrograms illustrating a polarizing film at normal incidence of P-polarized light and S-polarized light according to Example 17 of the present disclosure;

FIG. 19 is transmittance spectrograms illustrating a polarizing film at different incident angles of P-polarized light and S-polarized light according to Example 14 of the present disclosure;

FIG. 20 is transmittance spectrograms illustrating a polarizing film at different incident angles of P-polarized light and S-polarized light according to Example 14 of the present disclosure;

FIG. 21 is transmittance spectrograms illustrating a polarizing film at different

incident angles of P-polarized light and S-polarized light according to Example 14 of the present disclosure;

FIG. 22 is transmittance spectrograms illustrating a polarizing film at different incident angles of P-polarized light and S-polarized light according to Example 14 of the present disclosure;

FIG. 23 is transmittance spectrograms illustrating a polarizing film at a 0° incident angle of P-polarized light and S-polarized light in a visible wavelength range according to Example 1 and Examples 18-21 of the present disclosure;

FIG. 24 is transmittance spectrograms illustrating a polarizing film at normal incidence of P-polarized light and S-polarized light according to Example 18 of the present disclosure;

FIG. 25 is transmittance spectrograms illustrating a polarizing film at normal incidence of P-polarized light and S-polarized light according to Example 19 of the present disclosure;

FIG. 26 is transmittance spectrograms illustrating a polarizing film at normal incidence of P-polarized light and S-polarized light according to Example 20 of the present disclosure;

FIG. 27 is transmittance spectrograms illustrating a polarizing film at normal incidence of P-polarized light and S-polarized light according to Example 21 of the present disclosure;

FIG. 28 is transmittance spectrograms illustrating a polarizing film at different incident angles of P-polarized light and S-polarized light according to Example 18 of the present disclosure;

FIG. 29 is transmittance spectrograms illustrating a polarizing film at different incident angles of P-polarized light and S-polarized light according to Example 19 of the present disclosure;

FIG. 30 is transmittance spectrograms illustrating a polarizing film at different incident angles of P-polarized light and S-polarized light according to Example 20 of the present disclosure;

FIG. 31 is transmittance spectrograms illustrating a polarizing film at different incident angles of P-polarized light and S-polarized light according to Example 21 of the present disclosure;

FIG. 32 is transmittance spectrograms illustrating a polarizing film at a 0° incident angle of P-polarized light and S-polarized light in a visible wavelength range according to Example 1 and Examples 22-26 of the present disclosure;

FIG. 33 is transmittance spectrograms illustrating a polarizing film at normal incidence of P-polarized light and S-polarized light according to Example 22 of the present disclosure;

FIG. 34 is transmittance spectrograms illustrating a polarizing film at normal incidence of P-polarized light and S-polarized light according to Example 23 of the present disclosure;

FIG. 35 is transmittance spectrograms illustrating a polarizing film at normal incidence of P-polarized light and S-polarized light according to Example 24 of the present disclosure;

FIG. 36 is transmittance spectrograms illustrating a polarizing film at normal incidence of P-polarized light and S-polarized light according to Example 25 of the present disclosure;

FIG. 37 is transmittance spectrograms illustrating a polarizing film at normal incidence of P-polarized light and S-polarized light according to Example 26 of the present disclosure;

FIG. 38 is transmittance spectrograms illustrating a polarizing film at different incident angles of P-polarized light and S-polarized light according to Example 22 of the present disclosure;

FIG. 39 is transmittance spectrograms illustrating a polarizing film at different incident angles of P-polarized light and S-polarized light according to Example 23 of the present disclosure;

FIG. 40 is transmittance spectrograms illustrating a polarizing film at different incident angles of P-polarized light and S-polarized light according to Example 24 of the present disclosure;

FIG. 41 is transmittance spectrograms illustrating a polarizing film at different incident angles of P-polarized light and S-polarized light according to Example 25 of the present disclosure;

FIG. 42 is transmittance spectrograms illustrating a polarizing film at different incident angles of P-polarized light and S-polarized light according to Example 26 of the present disclosure;

FIG. 43 is transmittance spectrograms illustrating a polarizing film at normal incidence of P-polarized light and S-polarized light according to Example 27 of the present disclosure;

FIG. 44 is reflectance spectrograms illustrating a P-polarized light and S-polarized light of a polarizing film according to Example 27 of the present disclosure; and

FIG. 45 is transmittance spectrograms illustrating a polarizing film at different incident angles of P-polarized light and S-polarized light according to Example 27 of the present disclosure.

### DETAILED DESCRIPTION

In order to make the above purposes, features and advantages of the present disclosure more obvious and easier to understand, the specific embodiments of the present disclosure are described in detail below with reference to the accompanying drawings. In the following description, many specific details are set forth to facilitate a full understanding of the present disclosure. However, the present disclosure can be implemented in many other ways different from those described herein, and those skilled in the art can make similar improvements without violating the connotation of the present disclosure. Therefore, the present disclosure is not limited to the specific embodiments disclosed below.

It should be noted that when a component is said to be “fixed to” another component, it may be directly on the component or there may be an intermediate component. If an element is said to be “attached” to another element, it may be directly attached to the other element or there may be an intermediate component. The terms “vertical,” “horizontal,” “left,” “right,” and similar expressions as used herein are used for illustrative purposes only.

Unless otherwise defined, all technical and scientific terms used herein have the same meanings as are commonly understood by those skilled in the art. Terms used herein in the specification are for the purpose of describing specific embodiments only and are not intended to limit the present disclosure. The term “and/or” as used herein encompasses any and all combinations of one or more relevant listed items.

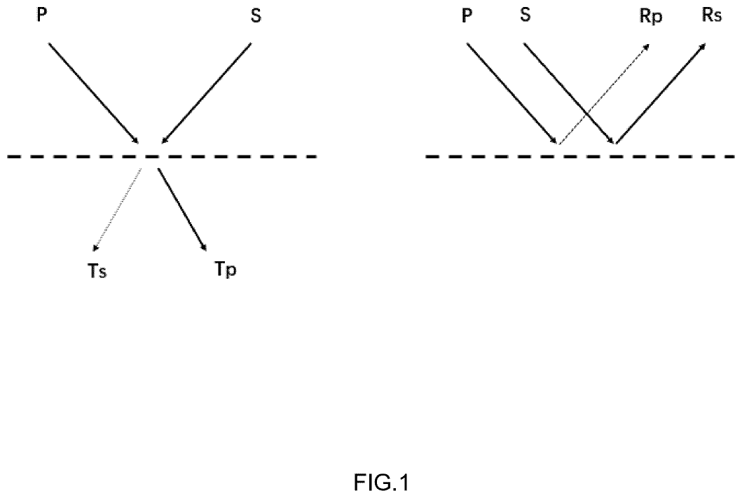

FIG. 1 is a schematic diagram illustrating optical properties of a polarizing film according to some embodiments of the present disclosure. If incident light containing S-polarized light and P-polarized light is incident onto the polarizing film, the P-polarized light may have a relatively high transmittance Tp, and the S-polarized light may have a relatively low transmittance Ts; meanwhile, the P-polarized light may have a relatively low reflectance Rp, and the S-polarized light may have a relatively high reflectance Rs.

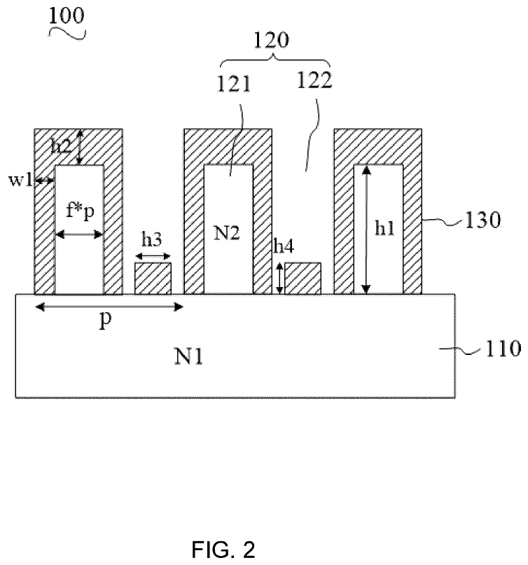

FIG. 2 is a schematic structural diagram illustrating a polarizing film according to some embodiments of the present disclosure. Referring to FIG. 2, the present disclosure provides a polarizing film 100 including a transparent substrate 110, a dielectric grating 120, and a metallic layer 130. The dielectric grating 120 may be disposed on the transparent substrate 110. The dielectric grating 120 may be provided with ridges 121 and grooves 122 which are periodically arranged at intervals. The metallic layer 130 may be configured to cover a top surface and a side surface of each of the ridges 121 of the dielectric grating 120 to cause at least a portion of a bottom of each of the grooves 122 of the dielectric grating 120 to be exposed.

The type of the polarizing film 100 is not limited in the present disclosure, and the polarizing film 100 may be a reflective film, a transmissive film, a diffractive film, etc.

The transparent substrate 110 is a substrate material configured to support the dielectric grating 120 and the metallic layer 130. In some embodiments, the dielectric grating 120 and the metallic layer 130 may be disposed on an upper layer of the transparent substrate 110.

In some embodiments, a shape of the transparent substrate 110 may include but is not limited to a circle, a quadrangle, a triangle, etc.

In some embodiments, parameters such as a transmittance, a refractive index N1, and a substrate type of the transparent substrate 110 may be determined based on actual application scenarios and needs.

In some embodiments, the transmittance of the transparent substrate 110 in visible light may be greater than 80%.

In some embodiments, the transmittance of the transparent substrate 110 in the visible light may be 85%, 90%, 95%, and 100%.

In some embodiments, the transmittance of the transparent substrate 110 in the visible light may be may be in a range of 80%-85%, 85%-90%, 90%-95%, 95%-100%, 80%-90%, 85%-95%, 90%-100%, 80%-95%, and 85%-100%.

In some embodiments, the refractive index N1 of the transparent substrate 110 may be in a range of 1.3-1.9.

In some embodiments, the refractive index N1 of the transparent substrate 110 may be at least one of 1.3, 1.45, 1.5, 1.6, 1.75, 1.8, 1.9, etc.

In some embodiments, the refractive index N1 of the transparent substrate 110 may be at least one of 1.3-1.45, 1.3-1.6, 1.3-1.8, 1.45-1.75, 1.5-1.8, 1.6-1.9, 1.75-1.9, etc.

In some embodiments, the transparent substrate 110 may include various types of transparent substrates, such as a rigid substrate, a semi-rigid substrate, etc. If the transparent substrate 110 is the rigid substrate, a material of the rigid substrate may include one or more of glass, a silicon wafer, etc.; if the transparent substrate 110 is the semi-rigid substrate, the material of the semi-rigid substrate may include one or more of polyimide (PI), polyethylene naphthalene dicarboxylate (PEN), etc.

In some embodiments, the transparent substrate 110 may be a flexible substrate.

In some embodiments, if the transparent substrate 110 is the flexible substrate, a material of the flexible substrate may be one or more of ultra-high molecular weight polyethylene (UHMWPE), unsaturated polyester (UP), etc.

In some embodiments, the material of the flexible substrate may be at least one of polycarbonate (PC), polyvinyl chloride (PVC), polyethylene terephthalate (PET), polymethylmethacrylate (PMMA), polypropylene (PP), and cellulose triacetate (TAC).

In some embodiments of the present disclosure, by setting the transparent substrate 110 as the flexible substrate, the flexible manufacturing of the polarizing film 100 can be applied to some scenarios in which the flexible polarizing film 100 is required, thereby expanding the application range of the polarizing film 100.

In some embodiments, a thickness of the transparent substrate 110 may be determined based on actual application scenarios and needs.

In some embodiments, the thickness of the transparent substrate 110 may be in a range of 0.5 μm-500 μm.

In some embodiments, the thickness of the transparent substrate 110 may be at least one of 0.5 Σm, 1 μm, 5 μm, 10 μm, 50 μm, 100 μm, 200 μm, 300 μm, 400 μm, 500 μm, etc.

In some embodiments, the thickness of the transparent substrate 110 may be at least one of 0.5 μm-10 μm, 0.5 μm-50 μm, 0.5 μm-100 μm, 0.5 μm-200 μm, 0.5 μm-300 μm, 0.5 μm-400 μm, 10 μm-500 μm, etc.

The dielectric grating 120 refers to an optical element having a periodic structure. In some embodiments, the dielectric grating 120 may be provided with ridges 121 and grooves 122 which are periodically arranged at intervals. The ridges 121 refer to raised portions of the periodic structures on a surface of the dielectric grating 120, and the grooves 122 refer to recessed portions of the periodic structures the surface of the dielectric grating 120.

Being periodically arranged at intervals means that the ridges 121 and the grooves 122 are periodically arranged in a specific mode on the dielectric grating 120. In some embodiments, the ridges 121 and the grooves 122 being periodically arranged in a specific mode may include that the ridges 121 and the grooves 122 of the dielectric grating 120 are alternately arranged at intervals with one groove 122 being disposed between two adjacent ridges 121. The ridges 121 of the dielectric grating 120 may be disposed in a region enclosed by the metallic layer 130 and the transparent substrate 110, i.e., a bottom of each of the ridges 121 contacts with the transparent substrate 110, and a remaining portion of each of the ridges 121 is cover by the metallic layer 130.

In some embodiments, parameters of the dielectric grating 120 may include but are not limited to a period p of the dielectric grating 120, a duty ratio f of the dielectric grating 120, a thickness h1 of each of the ridges of the dielectric grating 120, a refractive index N2 of the dielectric grating 120, a material of the dielectric grating 120, etc. The period of the dielectric grating 120 refers to a distance between the two adjacent ridge 121; the duty ratio of the dielectric grating 120 refers to a ratio of a width of each of the ridges 121 to the period; and the thickness of each of the ridges of the dielectric grating 120 refers to a height of the ridge 121 from the bottom to the top surface of the grooves 122.

In some embodiments, the period p, the duty ratio f, the thickness h1 of each of the ridges, the refractive index N2, the material, or the like, of the dielectric grating 120 may be determined based on actual application scenarios and needs.

In some embodiments, the period p of the dielectric grating 120 may be in a range of 50 nm-150 nm, the duty ratio f of the dielectric grating 120 may be in a range of 0.1-0.5, and the thickness h1 of each of the ridges 121 of the dielectric grating 120 may be in a range of 30 nm-110 nm.

In some embodiments, the period p of the dielectric grating 120 may be at least one of 50 nm, 60 nm, 75 nm, 80 nm, 90 nm, 100 nm, 110 nm, 125 nm, 130 nm, 140 nm, 150 nm, etc.

In some embodiments, the period p of the dielectric grating 120 may be at least one of 50 nm-75 nm, 50 nm-100 nm, 50 nm-125 nm, 75 nm-100 nm, 75 nm-150 nm, 100 nm-150 nm, 125 nm-150 nm, etc.

In some embodiments, the duty ratio f of the dielectric grating 120 may be at least one of 0.1, 0.2, 0.3, 0.4, 0.5, etc.

In some embodiments, the duty ratio f of the dielectric grating 120 may be at least one of 0.1-0.2, 0.1-0.3, 0.1-0.4, 0.2-0.4, 0.2-0.5, 0.3-0.5, 0.4-0.5, etc.

In some embodiments, the thickness h1 of each of the ridges 121 of the dielectric grating 120 may be at least one of 30 nm, 40 nm, 50 nm, 60 nm, 75 nm, 80 nm, 90 nm, 100 nm, 110 nm, etc.

In some embodiments, the thickness h1 of each of the ridges 121 of the dielectric grating 120 may be at least one of 30 nm-50 nm, 30 nm-75 nm, 30 nm-90 nm, 50 nm-90 nm, 50 nm-110 nm, 75 nm-110 nm, 90 nm-110 nm, etc.

In some embodiments, the refractive index N2 of the dielectric grating 120 may be in a range of 1.3-1.7.

In some embodiments, the refractive index N2 of the dielectric grating 120 may be at least one of 1.3, 1.4, 1.5, 1.6, 1.7, etc.

In some embodiments, the refractive index N2 of the dielectric grating 120 may be at least one of 1.3-1.4, 1.3-1.5, 1.3-1.6, 1.4-1.6, 1.4-1.7, 1.5-1.7, 1.3-1.7, 1.6-1.7, etc.

In some embodiments of the present disclosure, by setting the refractive index of the transparent substrate 110 and the dielectric grating 120, the optical properties of the polarizing film 100 can be optimized, and the polarization efficiency and contrast thereof can be improved, so as to enhance the display effect and visual experience.

In some embodiments, the material of the dielectric grating 120 may include one or more of polyethylene (PE), polypropylene (PP), etc.

In some embodiments, the material of the dielectric grating 120 may a resin-based curing adhesive. In some embodiments, the resin-based curing adhesive may be a UV adhesive, or other resin-based curing adhesives.

In some embodiments of the present disclosure, by setting the material of the dielectric grating 120, it ensures that the dielectric grating 120 has good optical properties and mechanical stability, thereby enhancing the overall performance of the polarizing film 100.

The metallic layer 130 refers to a thin metallic film covering the dielectric grating.

In some embodiments, at least a portion of the bottom of each of the grooves 122 of the dielectric grating 120 may be exposed out of the metallic layer 130, which facilitates the transmission of incident light through the grooves 122 of the dielectric grating 120, thereby increasing the transmittance of the P-polarized light.

In some embodiments, a thickness and a width of the metallic layer 130 at different positions on the surface of the dielectric grating 120 may be determined based on actual application scenarios and needs.

In some embodiments, a thickness h2 of a portion of the metallic layer 130 located on the top surface of each of the ridges 121 may be in range of 30 nm-150 nm, and a thickness w1 of a portion of the metallic layer 130 located on the side surface of each of the ridges 121 may be in a range of 5 nm-50 nm.

In some embodiments, the thickness h2 of the portion of the metallic layer 130 located on the top surface of each of the ridges 121 may be at least one of 30 nm, 35 nm, 50 nm, 65 nm, 70 nm, 80 nm, 95 nm, 100 nm, 110 nm, 120 nm, 130 nm, 140 nm, 150 nm, etc.

In some embodiments, the thickness h2 of the portion of the metallic layer 130 located on the top surface portion of each of the ridges 121 may be at least one of 30 nm-65 nm, 30 nm-95 nm, 30 nm-120 nm, 65 nm-120 nm, 65 nm-150 nm, 95 nm-150nm, 120 nm-150 nm, etc.

In some embodiments, the thickness w1 of the portion of the metallic layer 130 located on the side surface of each of the ridges 121 may be at least one of 5 nm, 15 nm, 20 nm, 25 nm, 35 nm, 45 nm, 50 nm, etc.

In some embodiments, the thickness w1 of the portion of the metallic layer 130 located on the side surface of each of the ridges 121 may be at least one of 5 nm-15 nm, 5 nm-25 nm, 5 nm-35 nm, 5 nm-45 nm, 15 nm-35 nm, 25 nm-45 nm, 35 nm-50 nm, etc.

In some embodiments of the present disclosure, by the optimized design of the structural parameters such as the period, the duty ratio, the thickness of each of the ridges, the thickness of the metallic layer 130, or the like, of the polarizing film 100, the optical properties such as a low absorption loss, a high extinction ratio, and a wide incident angle can be considered, which is of great practical significance for manufacturing new optical devices.

In some embodiments, a width h3 of a portion of the metallic layer 130 located on the bottom of each of the grooves 122 of the dielectric grating 120 may be in a range of 0 nm-50 nm, and a thickness h4 of the portion of the metallic layer 130 located on the bottom of each of the grooves 122 of the dielectric grating 120 may be in a range of 0 nm-50 nm.

In some embodiments, the width h3 of the portion of the metallic layer 130 located on the bottom of each of the grooves 122 of the dielectric grating 120 may be at least one of 0 nm, 10 nm, 20 nm, 30 nm, 40 nm, 50 nm, etc.

In some embodiments, the width h3 of the portion of the metallic layer 130 located on the bottom of each of the grooves 122 of the dielectric grating 120 may be at least one of 0 nm-10 nm, 0 nm-20 nm, 0 nm-30 nm, 0 nm-40 nm, 10 nm-30 nm, 20 nm-40 nm, 30 nm-50 nm, etc.

In some embodiments, the thickness h4 of the portion of the metallic layer 130 located on the bottom of each of the grooves 122 of the dielectric grating 120 may be at least one of 0 nm, 10 nm, 20 nm, 30 nm, 40 nm, 50 nm, etc.

In some embodiments, the thickness h4 of the portion of the metallic layer 130 located on the bottom of each of the grooves 122 of the dielectric grating 120 may be at least one of 0 nm-10 nm, 0 nm-20 nm, 0 nm-30 nm, 0 nm-40 nm, 10 nm-30 nm, 20 nm-40 nm, 30 nm-50 nm, etc.

In some embodiments of the present disclosure, by setting the width and the thickness of the portion of the metallic layer 130 located on the bottom of each of the grooves 122 of the dielectric grating 120, the propagation path of the light and the phase difference can be more accurately controlled, thereby enhancing the performance of the polarizing film 100.

In some embodiments, a material of the metallic layer 130 may be one or more metallic materials.

In some embodiments, the material of the metallic layer 130 may be at least one of gold, silver, copper, aluminum, and tungsten.

In some embodiments of the present disclosure, by setting the material of the metallic layer 130, the performance of the polarizing film can be optimized by different optical and electrical properties of the metal.

In some embodiments, the polarizing film 100 may further include a protective layer (not shown in the figures) configured to cover the transparent substrate 110, the dielectric grating 120, and the metallic layer 130. A refractive index of the protective layer may be determined based on actual application scenarios and needs.

In some embodiments, the refractive index of the protective layer may be in a range of 1.3-1.7, and a distance between a surface of the protective layer away from the transparent substrate and the metallic layer may be in a range of 0 nm-300 nm.

In some embodiments, the refractive index N3 of the protective layer may be at least one of 1.3, 1.4, 1.5, 1.6, 1.7, etc.

In some embodiments, the refractive index N3 of the protective layer may be at least one of 1.3-1.4, 1.3-1.5, 1.3-1.6, 1.4-1.5, 1.4-1.6, 1.4-1.7, 1.5-1.7, etc.

In some embodiments of the present disclosure, the optical properties of the polarizing film 100 can be further optimized by setting the refractive index and the position of the protective layer.

In some embodiments, a material of the protective layer may be one or more inorganic materials, such as aluminum oxide (Al₂O₃), silicon nitride (Si₃N₄), titanium dioxide (TiO₂), etc.

In some embodiments, the material of the protective layer may be at least one of SiO₂, MgF₂, and SiON.

In some embodiments of the present disclosure, by selecting the material of the protective layer, it facilitates the protective layer to have good optical properties and chemical stability.

In some embodiments of the present disclosure, by adding the protective layer to the polarizing film 100, the transparent substrate 110, the dielectric grating 120, and the metallic layer 130 can be protected, and oxidation of the metallic layer 130 can be prevented.

It should be noted that the structure of the polarizing film of the present disclosure is not limited to the polarizing film 100 of the above embodiment, but may also be other novel structures.

In some embodiments of the present disclosure, the metallic layer 130 of the polarizing film 100 may cover the top surface and the side surface of the ridge 121 of the dielectric grating 120. Since the dielectric grating 120 and the metallic layer 130 have different refractive indexes, values of equivalent refractive indexes of the S-polarized light and the P-polarized light are different. The grating structure of the present disclosure improves the reflectance of the S-polarized light and the transmittance of the P-polarized light as compared to a pure metallic grating, and thus the polarizing film 100 of the present disclosure has the optical properties of reducing the absorption loss and improving the extinction ratio. In addition, the polarizing film 100 designed in the present disclosure possesses a relatively large angular tolerance, which is suitable for application scenarios with large angles. Accordingly, the polarizing film realizes the optical properties of low absorption loss, high extinction ratio, and wide incident angle, which facilitates wide application.

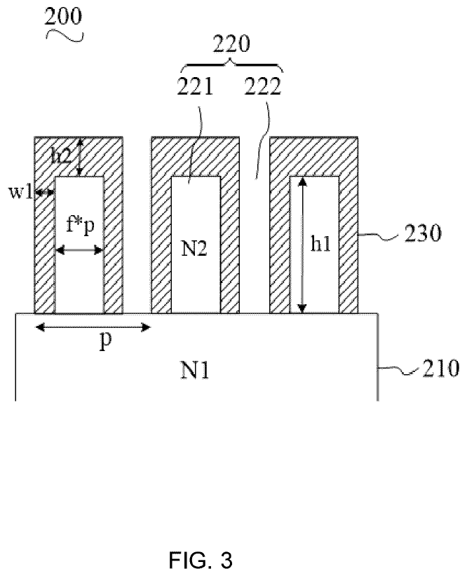

FIG. 3 is a schematic structural diagram illustrating a polarizing film according to other embodiments of the present disclosure. Referring to FIG. 3, a polarizing film 200 according to some embodiments of the present disclosure may include a transparent substrate 210, a dielectric grating 220, and a metallic layer 230. The dielectric grating 220 may be disposed on the transparent substrate 210. The dielectric grating 220 may be provided with ridges 221 and grooves 222 which are periodically arranged at intervals. The metallic layer 230 may be configured to cover a top surface and a side surface of each of the ridges 221 of the dielectric grating 220.

In some embodiments, at least a portion of a bottom of each of the grooves 222 of the dielectric grating 220 may be exposed out of the metallic layer 230.

In some embodiments, the bottom of each of the grooves 222 of the dielectric grating 220 may be completely exposed out of the metallic layer 230.

In some embodiments of the present disclosure, the bottom of each of the grooves 222 of the dielectric grating 220 may be completely exposed out of the metallic layer 230, which facilitates the transmission of incident light through the grooves 222 of the dielectric grating 220, thereby increasing the transmittance of the P-polarized light.

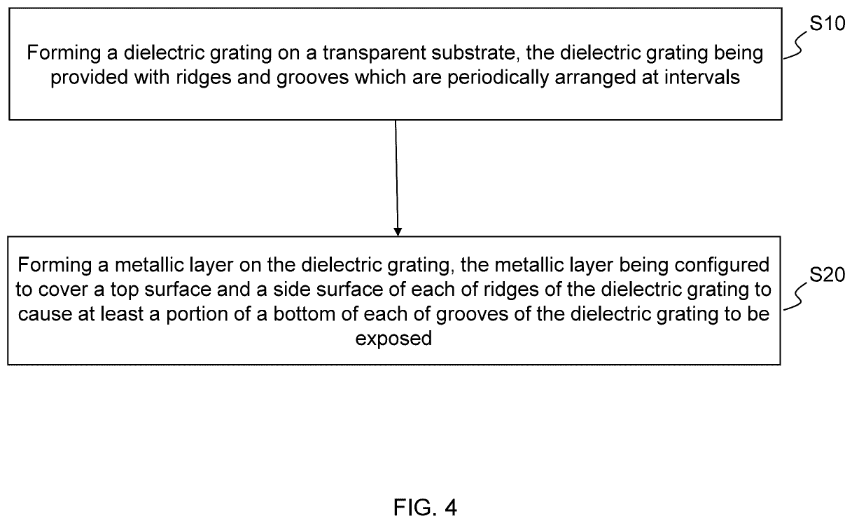

FIG. 4 is a flowchart illustrating a manufacturing method of a polarizing film according to some embodiments of the present disclosure. Referring to FIG. 4, the present disclosure provides the manufacturing method of the polarizing film. The manufacturing method may include the following operations.

S10, a dielectric grating may be on a transparent substrate, the dielectric grating being provided with ridges and grooves which are periodically arranged at intervals.

More descriptions regarding the transparent substrates and the dielectric gratings may be found in FIG. 2 and the related descriptions thereof.

In some embodiments, the dielectric grating may be formed on the transparent substrate in various ways. For example, the dielectric grating may be formed on the transparent substrate using nanoimprint lithography (NIL).

In some embodiments, forming the dielectric grating on the transparent substrate may include: attaching the transparent substrate to an imprinting template, an imprinting adhesive being coated between the transparent substrate and the imprinting template, then pressing the transparent substrate and the imprinting template, and demolding the imprinting template from the imprinting adhesive after the imprinting adhesive is cured to form the dielectric grating on the transparent substrate. The imprinting template is a rigid master template having a grooved structure, and the grooved structure matches a structure and a size of the dielectric grating.

In some embodiments, the imprinting adhesive may be coated on the transparent substrate or the imprinting template prior to attaching the transparent substrate to the imprinting template.

In some embodiments, the dielectric grating may be formed on the transparent substrate in other feasible ways.

In some embodiments, before imprinting the transparent substrate to the imprinting template, an imprinting pressure for forming the dielectric grating may be preset by a processor or other computing devices, and then the imprinting pressure may be sent to an imprinting device to control the imprinting device to perform imprinting.

In some embodiments, the processor may determine the imprinting pressure for forming the dielectric grating on the transparent substrate in various ways. For example, the imprinting pressure may be preset by those skilled in the art based on experience.

In some embodiments, the processor may determine, based on imprinting adhesive material data and transparent substrate material data, a retention force between the transparent substrate and the imprinting adhesive through a retention force prediction model; and determine, based on the retention force, the imprinting adhesive material data, the structural parameters and dimensional parameters of the dielectric grating, and a imprinting adhesive temperature, the imprinting pressure for forming the dielectric grating.

The imprinting adhesive material data reflects material properties of the imprinting adhesive. In some embodiments, the imprinting adhesive material data may include but is not limited to hardness, fluidity, viscosity, a material type, or the like, of the imprinting adhesive.

The transparent substrate material data reflects material properties of the transparent substrate. In some embodiments, the transparent substrate material data may include but is not limited to surface roughness, hardness, a material type, or the like, of the transparent substrate.

The imprinting adhesive material data and the transparent substrate material data may be obtained by a relevant monitoring device (e.g. a hardness tester, a viscometer, etc.). In some embodiments, the imprinting adhesive material data may be obtained by user input.

The retention force prediction model is a prediction model for determining the retention force between the transparent substrate and the imprinting adhesive. In some embodiments, the retention force prediction model may be any one of a deep neural networks (DNN) model, or other customized model structures, or any combination thereof.

In some embodiments, an input of the retention force prediction model may include the imprinting adhesive material data and the transparent substrate material data, and an output of the retention force prediction model may include the retention force between the transparent substrate and the imprinting adhesive.

The retention force reflects an interaction strength between the imprinting adhesive and the transparent substrate. In some embodiments, the retention force of the transparent substrate to the imprinting adhesive may be negatively correlated with a shedding probability of the imprinting adhesive from the transparent substrate. For example, the higher the shedding probability of the imprinting adhesive from the transparent substrate, the smaller the interaction strength between the imprinting adhesive and the transparent substrate, and the less the retention force.

The retention force prediction model may be obtained by training based on a large number of first training samples with first labels. In some embodiments, the first training samples may include sample imprinting adhesive material data and sample transparent substrate material data, and the first labels may include a sample retention force corresponding to one of the first training samples. In some embodiments, the first training sample may be obtained based on historical data. Historical imprinting records with a plurality of same imprinting pressures may be obtained from the historical data, historical shedding probabilities of the imprinting adhesive from the transparent substrate may be statistically obtained, historical retention forces determined based on the historical shedding probabilities may be determined as the first labels.

A training process of the retention force prediction model may include: obtaining the plurality of first training samples with the first labels to form a first training sample set, and performing a plurality of iterations based on the first training sample set. At least one of the iterations may include: selecting one or more first training samples from the training data set, inputting the one or more first training samples into an initial retention force prediction model to obtain model prediction outputs corresponding to the one or more first training samples; substituting the model prediction outputs corresponding to the one or more first training samples, and the first labels corresponding to the one or more first training samples into a predefined formula of a loss function to calculate a value of the loss function; iteratively updating model parameters of the initial retention force prediction model based on the value of the loss function until an iteration end condition is satisfied, and ending the iteration to obtain a trained retention force prediction model. The iteratively updating the model parameters of the initial retention force prediction model may be performed in various ways. For example, the iteratively updating the model parameters of the initial retention force prediction model may be performed based on gradient descent. The iteration end condition may include the loss function converging, or a count of iterations reaching a count threshold of iterations, etc.

In some embodiments, the imprinting pressure to form the dielectric grating may be determined based on the retention force, the imprinting adhesive material data, the structural parameters and the dimensional parameters of the dielectric grating, and the imprinting adhesive temperature.

The structural parameters of the dielectric grating are parameters related to the structure of the dielectric grating. More descriptions regarding the structural parameters may be found in FIG. 2 and FIG. 3 and the related descriptions thereof.

The dimensional parameters are parameters related to a size of the dielectric grating, such as the period, the duty ratio, the thickness of each of the ridges, or the like, of the dielectric grating. More descriptions regarding the dimensional parameters may be found in FIG. 2 and the related descriptions thereof.

The imprinting adhesive temperature is a temperature of the imprinting adhesive when the imprinting is performed. In some embodiments, the imprinting adhesive temperature may be preset based on prior experience.

The imprinting pressure is a pressure at which the imprinting is performed. The imprinting pressure may be obtained in various ways. For example, the imprinting pressure may be obtained through a first vector database.

In some embodiments, a first feature vector may be constructed based on the retention force between the transparent substrate and the imprinting adhesive, the structural parameter of the dielectric grating, the imprinting adhesive material data, the dimensional parameters, and the imprinting adhesive temperature; a first correlation vector may be determined by performing vector matching in the first vector database based on the first feature vector; and the imprinting pressure may be determined based on the first correlation vector.

In some embodiments, the first feature vector may be constructed in various ways. For example, the first feature vector may be constructed through term frequency-inverse document frequency (TF-IDF), one-hot, word2vec, etc.

The first vector database may include a plurality of first reference vectors and corresponding vector labels. The first vector database may be constructed based on historical data. For example, the processor may obtain a plurality of historical imprinting records, and construct one first reference vector based on historical retention forces corresponding to historical imprinting of the same batch, historical structural parameters, historical imprinting adhesive material data, historical dimensional parameters, and historical imprinting adhesive temperatures. The first reference vector may be constructed in a similar manner as the first feature vector. The vector label corresponding to the first reference vector may be a preferred imprinting pressure corresponding to the first reference vector. The preferred imprinting pressure may be a historical imprinting pressure corresponding to a finished imprinting product with the smallest surface roughness among the plurality of historical imprinting records corresponding to the first reference vectors.

In some embodiments, vector matching may be performed in the first vector database based on the first feature vector, and the first reference vector that satisfies a vector matching condition may be used as the first correlation vector. The vector matching condition may include a vector distance satisfying a distance threshold, the vector distance being minimum, or the like.

In some embodiments, a susceptibility to loss of the imprinting template may be determined based on a template material feature of the imprinting template; and the imprinting pressure may be adjusted based on a current loss degree and the susceptibility to loss of the imprinting template.

In some embodiments, the susceptibility to loss of the imprinting template may be determined based on the template material feature of the imprinting template.

The template material feature refers to the material of the imprinting template, such as metal, silicon, glass, ceramic, etc.

The susceptibility to loss refers to a degree to which the imprinting template is liable to loss during an imprinting process. The greater the susceptibility to loss, the greater the loss of the imprinting template during the imprinting process, and the poorer the accuracy of the dielectric grating obtained by imprinting.

The susceptibility to loss of the imprinting template may be preset based on prior experience. In some embodiments, the susceptibility to loss of the imprinting template may be positively correlated with a weight loss of the imprinting template to complete one imprinting process.

In some embodiments, the susceptibility to loss of the imprinting template may be determined based on the template material feature of the imprinting template. For example, the susceptibility to loss of the imprinting template may be determined by querying a first preset table. The first preset table may include a correspondence between the template material feature of the imprinting template and the susceptibility to loss. In some embodiments, the first preset table may be pre-constructed based on prior experience or historical data. For example, the processor may determine a historical susceptibility to loss by obtaining a historical weight loss of a historical imprinting template completing one imprinting process among the historical imprinting records. The first preset table may be constructed based on a historical template material feature and a corresponding historical susceptibility to loss.

In some embodiments, the imprinting pressure may be adjusted based on the current loss degree and the susceptibility to loss of the imprinting template.

The current loss degree is a current loss degree of the imprinting template. The current loss degree of the imprinting template may be obtained in various ways. For example, the current loss degree of the imprinting template may be determined based on actual detection.

In some embodiments, the current loss degree may be determined based on imprinting qualities of a plurality of historical finished imprinting products of the imprinting template.

The historical finished imprinting products are historical finished imprinting products obtained from a plurality of historical imprinting before a current imprinting operation.

The imprinting quality is a parameter for evaluating the quality of the finished imprinting product. In some embodiments, the imprinting quality may be negatively correlated with a degree to which the structural parameters and the dimensional parameters of the finished imprinting product deviates from a preset structural parameter and a preset dimensional parameter.

In some embodiments, the current loss degree may be determined by querying a second preset table. The second preset table may include a correspondence between an average value of the imprinting qualities of the historical finished imprinting products and the current loss degree. In some embodiments, the second preset table may be pre-constructed based on prior experience or historical data. For example, the processor may determine a historical moment from the historical imprinting records, obtain historical imprinting qualities of a preset count of finished imprinting products closest to the historical moment, and obtain an average value of the historical imprinting qualities by statistics, and a current loss degree corresponding to the average value of the historical imprinting qualities in the second preset table may be a historical susceptibility to loss of the historical imprinting template at the historical moment. The second preset table may be constructed by repeatedly selecting a plurality of historical moments.

In some embodiments of the present disclosure, the current loss degree may be determined based on the imprinting qualities of the plurality of historical finished imprinting products of the imprinting template, such that the service life of the imprinting template can be more accurately predicted, the parameters of the imprinting process can be optimized, and production defects caused by the loss of the imprinting template can be reduced, thereby improving the production efficiency and the product quality.

In some embodiments, the imprinting pressure may be adjusted based on the current loss degree and the susceptibility to loss of the imprinting template. For example, the imprinting pressure may be adjusted by operations S1-S3.

S1, a plurality of candidate imprinting pressures may be generated.

In some embodiments, a plurality of first reference vectors whose similarity to the first feature vector is greater than a preset similarity threshold may be selected from the first vector database, and the vector labels corresponding to the plurality of first reference vectors may be determined as the plurality of candidate imprinting pressures. The preset similarity threshold may be preset based on experience.

S2, for each of the plurality of candidate imprinting pressures, a predicted imprinting quality at the candidate imprinting pressure and a predicted loss degree of the imprinting template by the candidate imprinting pressure may be determined.

In some embodiments, a first reference vector corresponding to the candidate imprinting pressure may be obtained, and an average value of historical imprinting qualities and an average value of historical loss degrees of a plurality of historical finished imprinting products corresponding to the first reference vector may be determined as the predicted imprinting quality and the predicted loss degree of the candidate imprinting pressure.

In some embodiments, the historical loss degrees of the historical finished imprinting products may be positively correlated with a structural variation degree and a dimensional variation degree of the imprinting template before and after imprinting. For example, the greater the degree of bending, misalignment, and deformation of the imprinting template after imprinting, and the greater the dimensional variation degree (e.g., elongation, and thinning) of the imprinting template, the greater the historical loss degree. In some embodiments, a correspondence between the structural variation degree and the dimensional variation degree and the historical loss degree may be preset by those skilled in the art.

S3, a target imprinting pressure may be determined based on the predicted imprinting quality at the candidate imprinting pressure and the predicted loss degree of the imprinting template by the candidate imprinting pressure, and a current imprinting pressure may be adjusted to the target imprinting pressure.

In some embodiments, a candidate imprinting pressure corresponding to a maximum weighted sum of the predicted imprinting quality and the predicted loss degree may be determined as the target imprinting pressure. Weight coefficients for the predicted imprinting quality and the predicted loss degree may be y preset based on experience. The weight coefficient for the predicted loss degree may be a negative value.

In some embodiments of the present disclosure, by determining the susceptibility to loss of the imprinting template and adjusting the imprinting pressure, the imprinting process can be more accurately controlled, the imprinting quality can be optimized, and the service life of the imprinting template can be prolonged while improving the productivity and the product quality.

In some embodiments of the present disclosure, by determining the retention force between the transparent substrate and the imprinting adhesive and determining the imprinting pressure for forming the dielectric grating, the imprinting quality can be significantly improved, the process parameters can be optimized, and the service life of the imprinting template can be prolonged while reducing the production cost.

In some embodiments of the present disclosure, by forming the dielectric grating on the transparent substrate using the imprinting lithography, an accurate and efficient manufacturing process can be realized.

S20, a metallic layer may be on the dielectric grating, the metallic layer being configured to cover a top surface and a side surface of each of the ridges of the dielectric grating to cause at least a portion of a bottom of each of the grooves of the dielectric grating to be exposed, so as to obtain the polarizing film.

More descriptions regarding the metallic layer may be found in FIG. 2 and FIG. 3 and the related descriptions thereof.

In some embodiments, the metallic layer may be formed on the dielectric grating in various ways. For example, the metallic layer may be formed on the dielectric grating using a physical vapor deposition (PVD) technique, the metallic layer being configured to cover the top surface and the side surface of each of the ridges of the dielectric grating to cause at least a portion of the bottom of each of the grooves of the dielectric grating to be exposed, so as to obtain the polarizing film.

In some embodiments, forming the metallic layer on the dielectric grating may include: forming the metallic layer on the dielectric grating by a plating process, where aluminum (Al) is plated, a plating thickness is in a range of 5 nm-200 nm, a plating rate is in a range of 0.1 Å/S-10 Å/S, an evaporation power is in a range of 0-60%, an operation vacuum level is 5E-6 Torr, and a temperature is in a range of 25° C.-35° C.

In some embodiments, the plating thickness may be at least one of 5 nm, 10 nm, 20 nm, 30 nm, 50 nm, 75 nm, 100 nm, 125 nm, 150 nm, 175 nm, 200 nm, etc.

In some embodiments, the plating thickness may be at least one of 5 nm-20 nm, 5 nm-50 nm, 5 nm-100 nm, 5 nm-150 nm, 20 nm-100 nm, 50 nm-150 nm, 100 nm-200 nm, etc.

In some embodiments, the plating rate may be at least one of 0.1 Å/S, 0.5 Å/S, 1 Å/S, 2 Å/S, 5 Å/S, 10 Å/S, etc.

In some embodiments, the plating rate may be at least one of 0.1 Å/S-1 Å/S, 0.1 Å/S-2 Å/S, 0.1 Å/S-5 Å/S, 1 Å/S-5 Å/S, 1 Å/S-10 Å/S, 2 Å/S-10 Å/S, etc.

In some embodiments, the evaporation power may be at least one of 0%, 10%, 20%, 30%, 40%, 50%, 60%, etc.

In some embodiments, the evaporation power may be at least one of 0%-10%, 0%-20%, 0%-30%, 0%-40%, 0%-50%, 10%-30%, 20%-50%, 30%-60%, etc.

In some embodiments, the operation vacuum level may be 5E-6 Torr.

In some embodiments, the temperature may be at least one of 25° C., 26° C., 27° C., 28° C., 29° C., 30° C., 31° C., 32° C., 33° C., 34° C., 35° C., etc.

In some embodiments, the temperature may be at least one of 25° C.-27° C., 25° C.-29° C., 25° C.-33° C., 27° C.-31° C., 29° C.-35° C., etc.

The plating process may include: attaching the transparent substrate and the dielectric grating to a fixture using a high-temperature adhesive tape to place into a plating device together, vacuumizing, introducing O₂ and Ar₂, and setting plating parameters (including a plating type, plating time, the plating rate, etc.), and then forming the metallic layer on the dielectric grating after plating is completed.

In some embodiments, the plating type, the plating time, and the plating rate may be determined in various ways. For example, the plating type, the plating time, and the plating rate may be preset by those skilled in the art based on prior experience.

In some embodiments, the processor may predetermine a plating segment on the dielectric grating that needs plating, and determine plating rates corresponding to different plating segments. The plating rate may be sent to the plating device to control the plating device to perform plating.

In some embodiments, a plurality of different plating segments on the dielectric grating may be generated based on the structural parameters and the dimensional parameters of the dielectric grating. For each of the plating segments, the plating rate within the plating segment may be determined based on a microstructural feature of the dielectric grating within the plating segment, a plating layer dimension, an evaporation power, a vacuum degree, and a plating temperature.

The plating segment is a plating region obtained by dividing the dielectric grating.

In some embodiments, regions of the dielectric grating with the same plating layer thickness may be divided into the same plating segment.

In some embodiments, for each of the plating segments, the plating rate within the plating segment may be determined based on the microstructural feature of the dielectric grating within the plating segment, the plating layer dimension, the evaporation power, the vacuum degree, and the plating temperature.

The microstructural feature reflects a structural feature at a microscopic level. In some embodiments, the microstructural feature of the dielectric grating may include but is not limited to line edge neatness of the dielectric grating, groove depth uniformity, surface roughness, and a bubble impurity content.

In some embodiments, the microstructural feature of the dielectric grating may be obtained in various ways. For example, the microstructural feature of the dielectric grating may be obtained by a relevant detection device (e.g., scanning electron microscope, etc.).

In some embodiments, for each of the plating segments, the microstructural feature of the dielectric grating within the plating segment may be determined through microscopic prediction model based on the imprinting pressure, the imprinting adhesive material data, the structural parameters and the dimensional parameters of the dielectric grating, and the current loss degree of the imprinting template corresponding to the plating segment.

The microscopic prediction model is a prediction model for determining microstructural feature of the dielectric grating. The microscopic prediction model may include a loss-prone region extraction layer and a microstructure prediction layer. In some embodiments, the loss-prone region extraction layer may be configured to determine a loss-prone region of the dielectric grating, and the microstructure prediction layer may be configured to determine the microstructural feature of the dielectric grating.

In some embodiments, the loss-prone region extraction layer and the microstructure prediction layer of the microscopic prediction model may be any one of a deep neural networks (DNN) model, or other customized model structures, or any combination thereof

In some embodiments, an input of the loss-prone region extraction layer may include structural parameters and the dimensional parameters of the dielectric grating within the plating segment, and the imprinting adhesive material data, and an output of the loss-prone region extraction layer may include the loss-prone region of the dielectric grating within the plating segment.

In some embodiments, an input of the microstructure prediction layer may include the loss-prone region of the dielectric grating within the plating segment, the imprinting pressure, and the current loss degree of the imprinting template corresponding to the plating segment, and an output of the microstructure prediction layer may include the microstructural feature of the dielectric grating within the plating segment.

In some embodiments, the microstructure prediction layer and the loss-prone region extraction layer may be obtained by separate training.

The loss-prone region extraction layer may be obtained by training based on a large number of second training samples with second labels. In some embodiments, the second training samples may include sample structural parameters and sample dimensional parameters of a sample dielectric grating, and sample imprinting adhesive material data, and the second labels may include sample loss-prone regions corresponding to the second training samples. In some embodiments, the second training samples may be obtained based on historical data. Historical finished imprinting products obtained from a plurality of historical imprinting may be obtained from the historical data. Historical actual loss regions of the historical finished imprinting products within the plating segment may be obtained by statistics. The historical actual loss regions may be determined as the second labels. The historical actual loss regions may include but are not limited to regions where line edges are not neat, groove depths are not uniform, surfaces are rough, and/or bubbling impurities exist.

The microstructure prediction layer may be obtained by training based on a large number of third training samples with third labels. In some embodiments, the third training samples may include a sample loss-prone region, a sample imprinting pressure, and a sample loss degree of the sample imprinting template corresponding to the plating segment, and the third labels may include a sample microstructural feature of the sample dielectric grating corresponding to the third training samples. In some embodiments, the third training samples may be obtained based on historical data. Historical actual microstructural features of historical dielectric gratings may be determined from the historical data as the third labels.

A training process of the loss-prone region extraction layer and the microstructure prediction layer may be similar to the training process of the retention force prediction model, which may be found in the related descriptions above.

In some embodiments of the present disclosure, by determining microstructural feature of the dielectric grating through the microscopic prediction model, the prediction accuracy of the microstructural feature of the dielectric grating can be guaranteed while improving efficiency and reducing the cost of determining the microstructural feature.

The plating layer dimension reflects a geometric feature of a plating layer. In some embodiments, the plating layer dimension may include a thickness of the plating layer, etc.

More descriptions regarding the evaporation power, the vacuum degree, and the plating temperature may be found in the related descriptions above.

In some embodiments, the plating layer dimension, the evaporation power, the vacuum degree, and the plating temperature may be obtained by a monitoring device (e.g., a scanning electron microscope, a vacuum gauge, etc.).

In some embodiments, for each of the plating segments, the plating rate within the plating segment may be determined by querying a second vector database based on the microstructural feature of the dielectric grating within the plating segment, the plating layer dimension, the evaporation power, the vacuum degree, and the plating temperature.

In some embodiments, a second feature vector may be constructed based on the microstructural features of the dielectric grating, the plating layer dimension, the evaporation power, the vacuum degree, and the plating temperature; a second correlation vector may be determined by performing vector matching in a second vector database based on the second feature vector; and the plating rate may be determined based on the second correlation vector.

In some embodiments, the second feature vector may be constructed in various ways. For example, the second feature vector may be constructed through term frequency-inverse document frequency (TF-IDF), one-hot, word2vec, etc.

The second vector database may include a plurality of second reference vectors and corresponding second vector labels. The second vector database may be constructed based on historical data. For example, the processor may obtain a plurality of historical plating records, and construct one second reference vector based on a historical microstructural feature of a historical dielectric grating, a historical plating layer dimension, a historical evaporation power, a historical vacuum degree, and a historical plating temperature corresponding to one of the historical plating records. The second reference vector may be constructed in a manner similar to the second feature vector. The second vector label may be a preferred plating rate corresponding to the second reference vector. The preferred plating rate may be a historical plating rate corresponding to a polarizing film with an optimal density uniformity among the plurality of historical plating records corresponding to the second reference vectors. The optimal density uniformity may be a minimum density standard deviation of a plurality of preset point positions on the polarizing film.

In some embodiments, vector matching may be performed in the second vector database based on the second feature vector, and a second reference vector that satisfies a second vector matching condition may be used as a second correlation vector. The second vector matching condition may include a vector distance satisfying a distance threshold, the vector distance being minimum, or the like.

In some embodiments of the present disclosure, by generating different plating segments and determining the plating rate within each of the plating segments, fine control of the microstructural feature of the dielectric grating can be achieved, thereby optimizing the plating quality and improving the optical properties and reliability of the dielectric grating.

In some embodiments of the present disclosure, the uniformity and quality of the metallic layer on the dielectric grating can be ensured by the plating process.

In some embodiments of the present disclosure, the polarizing film having the novel structure of the present disclosure can be manufactured by adopting the manufacturing method of the polarizing film. It is verified that the above polarizing film can realize the optical properties of the low absorption loss, the high extinction ratio, and the wide incident angle, thereby facilitating wide application.

One or more embodiments of the present disclosure provide a display device (not shown in the figures). The display device may include any polarizing film described above.

In some embodiments, the display device may be an optical device that requires high contrast polarized light.

In some embodiments, the display device may be a projector, a polarizing beam splitter, or a head-up display. In some embodiments, the display device may be, for example, a projection optical system, an ar/vr system, a television, a computer, a consumer electronic display device, or polarized glasses.

In some embodiments of the present disclosure, by applying the polarizing film to the display device such as the projector, the polarizing beam splitter, or the head-up display, the display effect and the visual experience can be significantly improved.

In some embodiments of the present disclosure, the polarizing film can realize the optical properties of lower absorption loss, higher extinction ratio, and wide incident angle, thereby enhancing the performance of the display device adopting the polarizing film, and facilitating wide application of the display device.

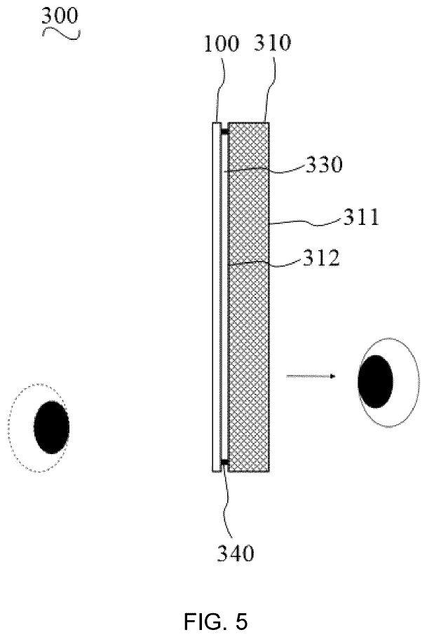

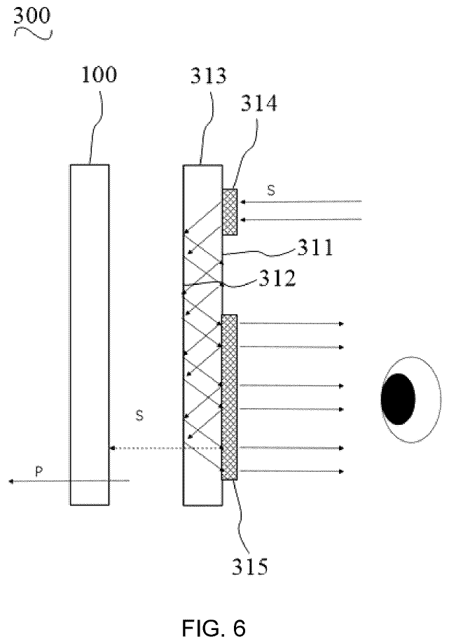

One or more embodiments of the present disclosure provide an optical waveguide lens. The optical waveguide lens may include any polarizing film described above. FIG. 5 is a schematic diagram illustrating an overall optical waveguide lens according to some embodiments of the present disclosure. FIG. 6 is a schematic diagram illustrating light of an optical waveguide lens according to some embodiments of the present disclosure. Referring to FIG. 5 and FIG. 6, in some embodiments, the optical waveguide lens 300 may include an optical waveguide 310 and the polarizing film 100 as described above.

In some embodiments, the optical waveguide 310 may be provided with a light receiving surface 311 for receiving light and a backlight surface 312 disposed on an opposite side of the light receiving surface 311. In some embodiments, the polarizing film 100 may be configured to reflect S-polarized light and transmit P-polarized light. The polarizing film 100 may be disposed on the backlight surface 312 of the optical waveguide 310, and the transparent substrate of the polarizing film 100 may be disposed away from the optical waveguide 310. A gap 330 may be provided between the optical waveguide 310 and the polarizing film 100.

In some embodiments, in the optical waveguide lens 300, the optical waveguide 310 may include an optical waveguide body 313. Two functional regions, i.e. a coupling-in region 314 and a coupling-out region 315, may be provided on a surface of the optical waveguide body 313. A light beam may be first projected onto the coupling-in region 314, and a coupled light beam may be fed into the coupling-out region 315 after diffraction of the grating and total reflection of the waveguide, and the light beam is output to human eyes in a certain direction to realize the augmented reality display of the holographic diffractive waveguide lens. In addition, an image light may be incident from the coupling-in region 314 of the waveguide lens, and emergent out of the coupling-out region 315, so as to realize a horizontal field of view (FOV) expansion. Shapes of the two functional regions may be a circle, rectangle, a cone, or the like, which are not limited in the present disclosure. In some embodiments, other functional regions may be provided on the surface of the optical waveguide body 313, which may be set according to actual needs.

In some embodiments, the polarizing film 100 may be configured to prevent light from the optical waveguide 310 to the backlight surface 312. Specifically, the polarizing film 100 has a polarization beam splitting function that the polarizing film 100 has a relatively low transmittance to the S-polarized light, and thus front projection light cannot be received through the polarizing film 100; and the polarizing film 100 has a relatively high transmittance to the P-polarized light, and thus the P-polarized light in the ambient light can be received by an observer through the polarizing film 100 so as not to affect an observer's view of a real space.

In some embodiments, the gap 330 may be provided between the optical waveguide 310 and the polarizing film 100 to prevent the polarizing film from affecting imaging of the optical waveguide. An interior of the gap 330 is filled with air. The interior of the gap 330 may be filled with other gases that do not affect imaging of the optical waveguide.

In some embodiments, the transmittance of the polarizing film to the S-polarized light and the P-polarized light may be determined based on actual application scenarios and needs.

In some embodiments, the transmittance of the polarizing film 100 to the S-polarized light may be less than 5%, and the transmittance of the polarizing film 100 to the P-polarized light may be greater than 60%.

In some embodiments, the transmittance of the polarizing film 100 to the S-polarized light may be at least one of 0%, 1%, 2%, 3%, 4%, etc.

In embodiments, the transmittance of the polarizing film 100 to the S-polarized light may be at least one of 0%-1%, 0%-2%, 0%-3%, 1%-3%, 1%-4%, 2%-4%, etc.

In some embodiments, the transmittance of the polarizing film 100 to the P-polarized light may be at least one of 60%, 65%, 70%, 75%, 80%, 85%, 90%, 95%, 100%, etc.

In some embodiments, the transmittance of the polarizing film 100 to the P-polarized light may be at least one of 60%-70%, 60%-80%, 60%-90%, 70%-90%, 70%-100%, 80%-100%, etc.

In some embodiments, the polarizing film 100 has a very low transmittance to the S-polarized light, such that the front projection light cannot be received through the polarizing film 100; and the polarizing film 100 has a relatively high transmittance to the P-polarized light, such that ambient light in the P-polarized light can be received by the observer through the polarizing film 100 without affecting the observer's view of real space.

A distance between the optical waveguide 310 and the polarizing film 100 may be a width of the gap between the optical waveguide 310 and the polarizing film 100.

In some embodiments, the distance between the optical waveguide 310 and the polarizing film 100 may be determined based on actual application scenarios and needs.

In some embodiments, the distance between the optical waveguide 310 and the polarizing film 100 may be in a range of 1 μm-5 cm.

In some embodiments, the distance between the optical waveguide 310 and the polarizing film 100 may be at least one of 1 μm, 10 μm, 50 μm, 100 μm, 500 μm, 1 mm, 5 mm, 1 cm, 3 cm, 5 cm, etc.

In some embodiments, the distance between the optical waveguide 310 and the polarizing film 100 may be at least one of 1 μm-10 μm, 1 μm-50 μm, 1 μm-100 μm, 1 μm-500 μm, 1 μm-1 cm, 10 μm-5 mm, 50 μm-1 cm, 100 μm-5 cm, 1 mm-3 cm, 5 mm-5 cm, etc.

In some embodiments of the present disclosure, by setting the distance between the optical waveguide and the polarizing film, the polarizing film 100 does not to affect imaging of the optical waveguide 310, thereby guaranteeing the final imaging effect.

In some embodiments, the polarizing film may be fixed to the optical waveguide in various ways according to actual application scenarios and needs.

In some embodiments, the polarizing film 100 may be to the optical waveguide 310 through a bonding adhesive 340. The bonding adhesive may be disposed at an edge position of the polarizing film 100 and the optical waveguide 310. The bonding adhesive 340 may be an OCA adhesive, or other similar bonding adhesives.

In some embodiments of the present disclosure, by setting the fixing mode of the polarizing film, the stability and reliability of the polarizing film on the optical waveguide can be guaranteed.

In some embodiments, the optical waveguide lens may further include a rigid substrate (not shown in the figures) configured to support the polarizing film 100. The rigid substrate may fit a side of the polarizing film 100 away from the optical waveguide 310. The rigid substrate may be configured to support the polarizing film 100 to provide a rigid support effect for the polarizing film 100, thereby avoiding affecting the imaging effect caused by the polarizing film 100 completely fitting the optical waveguide 310.

In some embodiments of the present disclosure, by introducing the rigid substrate to the optical waveguide lens to support the polarizing film, imaging aberration and degradation of optical performance that may be caused by the polarizing film directly fitting the optical waveguide can be effectively reduced.

It should be noted that the polarizing film of the optical waveguide lens in the above embodiment of the present disclosure is not limited to the polarizing film 100 of the above embodiment, but may also be the polarizing film 200 of the other embodiment described above.

In some embodiments of the present disclosure, by applying the optical waveguide lens, front projection can be avoided, and the privacy of display is improved, which is conducive to wide application.

After experiments, it is verified that in some embodiments of the present disclosure, the polarizing film can realize the optical properties of lower absorption loss, higher extinction ratio, and wide incident angle, thereby enhancing the performance of the optical waveguide lens adopting the above polarizing film, and facilitating wide application of the optical waveguide lens.

Referring to the above embodiments, in order to make the technical solutions of the present disclosure more specific and clearer, and easy to understand, examples of the technical solutions of the present disclosure are given, but it should be noted that the contents to be protected by the present disclosure are not limited to the following Examples 1-27.

### Examples 1-26

The structure of the polarizing film 200 of Examples 1-26 is shown in FIG. 3, and the relevant structural parameters are shown in Table 1. In the polarizing film 200 of Example 1, the material of the transparent substrate 210 is polycarbonate (PC), the material of the dielectric grating 220 is a UV adhesive, and the material of the metallic layer 230 is aluminum.

The manufacturing method of the polarizing film 200 of Example 1 includes the following operations.

S1, a transparent substrate and an imprinting template are provided.

S2, an imprinting adhesive is coated on the transparent substrate, the transparent substrate is attached to the imprinting template, the transparent substrate and the imprinting template are pressed by a roller, then ultraviolet irradiation is performed on the imprinting adhesive, the transparent substrate is removed after the imprinting adhesive is cured, and the imprinting template is demolded from the imprinting adhesive to form the dielectric grating on the transparent substrate.

S3, the transparent substrate and the dielectric grating are attached to a fixture using a high-temperature adhesive tape, then placed into plating equipment, and vacuumized, process parameters of plating are set as follows: the plating rate is 5 Å/S, the evaporation power is 20%, the operation vacuum level is 5E-6 Torr, and the temperature is 30° C.; after the plating is completed, the metallic layer is formed on the dielectric grating.

The polarizing film 200 of Examples 2-26 is obtained by fitting of a 3D structural model.

### Example 27

The structure of the polarizing film 100 of Example 27 is shown in FIG. 2, and the relevant structural parameters are shown in Table 1. The material of the transparent substrate 110 is polycarbonate (PC), the material of the dielectric grating 120 is a UV adhesive, and the material of the metallic layer 130 is aluminum.

The manufacturing method of the polarizing film 100 of Example 27 includes the following operations.

S1, a transparent substrate and an imprinting template are provided.

S2, an imprinting adhesive is coated on the transparent substrate, the transparent substrate is attached to the imprinting template, the transparent substrate and the imprinting template are pressed by a roller, then ultraviolet irradiation is performed on the imprinting adhesive, the transparent substrate is removed after the imprinting adhesive is cured, and the imprinting template is demolded from the imprinting adhesive to form the dielectric grating on the transparent substrate.

S3, the transparent substrate and the dielectric grating are attached to a fixture using a high-temperature adhesive tape, then placed into plating equipment, and vacuumized, process parameters of plating are set as follows: the plating rate is 2 Å/S, the evaporation power is 10%, the operation vacuum level is 5E-6 Torr, and the temperature is 30° C.; after the plating is completed, the metallic layer is formed on the dielectric grating.

TABLE 1
Structural parameters of the polarizing film of Examples 1-27

| | Transparent | | Dielectric grating | | | | | | | |
|---|---|---|---|---|---|---|---|---|---|---|
| | substrate | | | | Ridge | | Metallic layer | | | |
| | Refractive | Thickness | Period | Duty | thickness | Refractive | Thickness | Thickness | Width | Thickness |
| Example | index N1 | (nm) | p (nm) | ratio f | h1 (nm) | index N2 | h2 (nm) | w1 (nm) | h3 (nm | h4 (nm) |
| Example | 1.6 | 100 | 100 | 0.1 | 75 | 1.5 | 65 | 20 | / | / |
| 1 | | | | | | | | | | |
| Example | 1.3 | 100 | 100 | 0.1 | 75 | 1.5 | 65 | 20 | / | / |
| 2 | | | | | | | | | | |
| Example | 1.45 | 100 | 100 | 0.1 | 75 | 1.5 | 65 | 20 | / | / |
| 3 | | | | | | | | | | |
| Example | 1.75 | 100 | 100 | 0.1 | 75 | 1.5 | 65 | 20 | / | / |
| 4 | | | | | | | | | | |
| Example | 1.9 | 100 | 100 | 0.1 | 75 | 1.5 | 65 | 20 | / | / |
| 5 | | | | | | | | | | |
| Example | 1.6 | 100 | 100 | 0.1 | 75 | 1.3 | 65 | 20 | / | / |
| 6 | | | | | | | | | | |
| Example | 1.6 | 100 | 100 | 0.1 | 75 | 1.4 | 65 | 20 | / | / |
| 7 | | | | | | | | | | |
| Example | 1.6 | 100 | 100 | 0.1 | 75 | 1.6 | 65 | 20 | / | / |
| 8 | | | | | | | | | | |
| Example | 1.6 | 100 | 100 | 0.1 | 75 | 1.7 | 65 | 20 | / | / |
| 9 | | | | | | | | | | |
| Example | 1.6 | 100 | 50 | 0.1 | 75 | 1.5 | 65 | 20 | / | / |
| 10 | | | | | | | | | | |
| Example | 1.6 | 100 | 75 | 0.1 | 75 | 1.5 | 65 | 20 | / | / |
| 11 | | | | | | | | | | |
| Example | 1.6 | 100 | 125 | 0.1 | 75 | 1.5 | 65 | 20 | / | / |
| 12 | | | | | | | | | | |
| Example | 1.6 | 100 | 150 | 0.1 | 75 | 1.5 | 65 | 20 | / | / |
| 13 | | | | | | | | | | |
| Example | 1.6 | 100 | 100 | 0.2 | 75 | 1.5 | 65 | 20 | / | / |
| 14 | | | | | | | | | | |
| Example | 1.6 | 100 | 100 | 0.3 | 75 | 1.5 | 65 | 20 | / | / |
| 15 | | | | | | | | | | |
| Example | 1.6 | 100 | 100 | 0.4 | 75 | 1.5 | 65 | 20 | / | / |
| 16 | | | | | | | | | | |
| Example | 1.6 | 100 | 100 | 0.5 | 75 | 1.5 | 65 | 20 | / | / |
| 17 | | | | | | | | | | |
| Example | 1.6 | 100 | 100 | 0.1 | 30 | 1.5 | 65 | 20 | / | / |
| 18 | | | | | | | | | | |
| Example | 1.6 | 100 | 100 | 0.1 | 50 | 1.5 | 65 | 20 | / | / |
| 19 | | | | | | | | | | |
| Example | 1.6 | 100 | 100 | 0.1 | 90 | 1.5 | 65 | 20 | / | / |
| 20 | | | | | | | | | | |
| Example | 1.6 | 100 | 100 | 0.1 | 110 | 1.5 | 65 | 20 | / | / |
| 21 | | | | | | | | | | |
| Example | 1.6 | 100 | 100 | 0.1 | 75 | 1.5 | 35 | 5 | / | / |
| 22 | | | | | | | | | | |
| Example | 1.6 | 100 | 100 | 0.1 | 75 | 1.5 | 50 | 15 | / | / |
| 23 | | | | | | | | | | |
| Example | 1.6 | 100 | 100 | 0.1 | 75 | 1.5 | 65 | 25 | / | / |
| 24 | | | | | | | | | | |
| Example | 1.6 | 100 | 100 | 0.1 | 75 | 1.5 | 80 | 35 | / | / |
| 25 | | | | | | | | | | |
| Example | 1.6 | 100 | 100 | 0.1 | 75 | 1.5 | 95 | 45 | / | / |
| 26 | | | | | | | | | | |
| Example | 1.6 | 100 | 100 | 0.1 | 75 | 1.5 | 30 | 15 | 30 | 30 |
| 27 | | | | | | | | | | |

Where “/” in Table 1 means the item does not exist.

### Performance Testing (Examples 1-26)

### (1) Transmittance

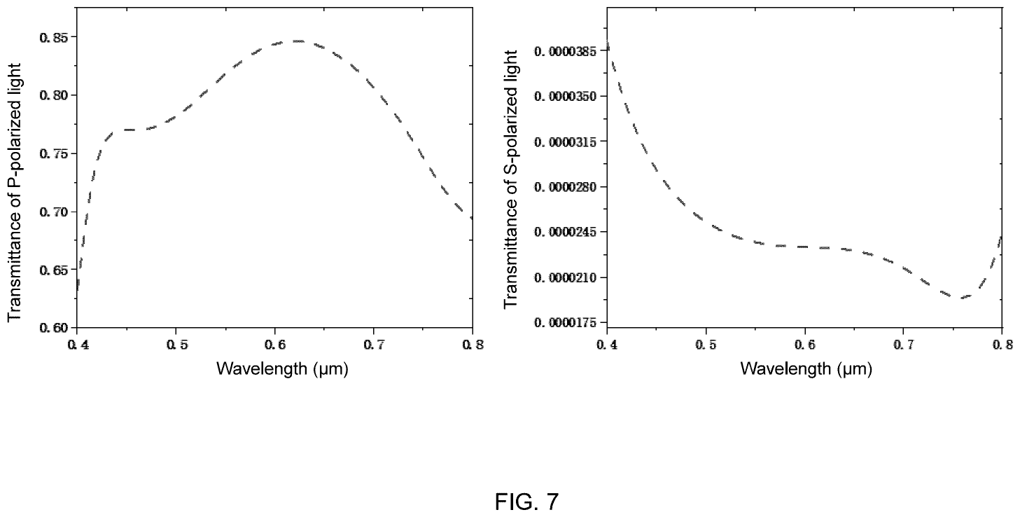

The polarizing film 200 of Example 1 is introduced into a 3D structural model and subjected to parameter calibration, and then transmittances of P-polarized light and S-polarized light at normal incidence are calculated by simulation based on rigorous coupled wave analysis (RCWA), as shown in FIG. 7. According to FIG. 7, the transmittance of the P-polarized light in a range of 400 nm-800 nm is 75% on average, with a maximum of 83%; and the transmittance of the S-polarized light in the range of 400 nm-800 nm is 0.0024% on average.

By calculating Tp and Tc at wavelengths of 450 nm, 550 nm, and 650 nm, corresponding values of extinction ratios are calculated, as shown in Table 2.According to the data shown in Table 2, the extinction ratio of the polarizing film 200 of Example 1 is 44.09 dB at the wavelength of 450 nm, 46.11 dB at the wavelength of 550nm, and 46.23 dB at the wavelength of 650 nm. The foregoing indicates that the polarizing film 200 of Example 1 has a relatively low absorption loss and a relatively high extinction ratio.

TABLE 2
Test data for the polarizing film 200 of Example 1

| Wavelength | 450 nm | 550 nm | 650 nm |
|---|---|---|---|
| Transmittance Tp | 77.02% | 81.8% | 84.05% |
| Transmittance Tc | 0.003% | 0.002% | 0.002% |
| Extinction Ratio | 44.09 dB | 46.11 dB | 46.23 dB |
| EXT | | | |

### (2) Reflectance

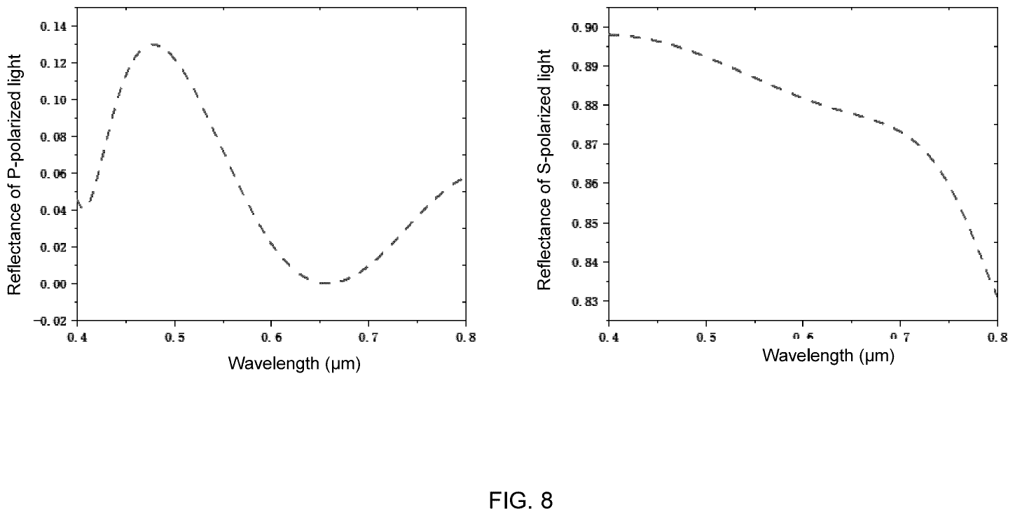

The polarizing film 200 of Example 1 is introduced into the 3D structural model and subjected to parameter calibration, and then reflectances of the P-polarized light and the S-polarized light are calculated by simulation based on the RCWA, as shown in FIG. 8. According to FIG. 8, the reflectance of the P-polarized light in a range of 400 nm-800 nm is 5% on average; and the reflectance of the S-polarized light in the range of 400 nm-800 nm is 88% on average, with a maximum of 89.8%. The foregoing indicates that the polarizing film 200 of Example 1 has a relatively low absorption loss and a relatively high extinction ratio.

### (3) Incident Angle Variation

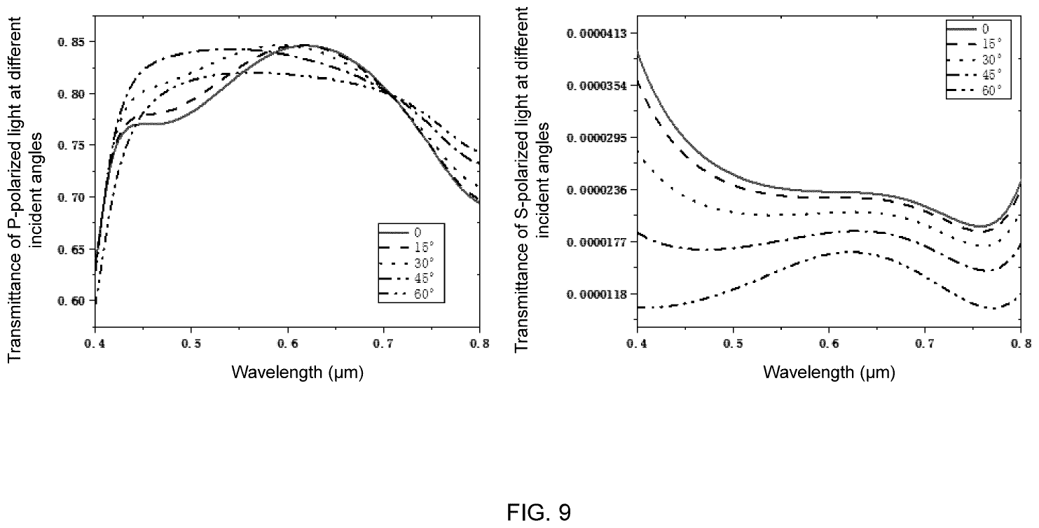

The polarizing film 200 of Example 1 is irradiated at different incident angles (0-60°), and transmittance spectrograms of the P-polarized light and the S-polarized light at different incident angles are obtained, as shown in FIG. 9. According to FIG. 9, if an incident angle varies from 0 to 60°, transmittance spectra of the P-polarized light and S-polarized light in a visible wavelength range are not much affected, which indicates that the polarizing film designed in the present disclosure has a relatively large angular tolerance, and the polarizing film is very suitable for the application scenarios with large angles.

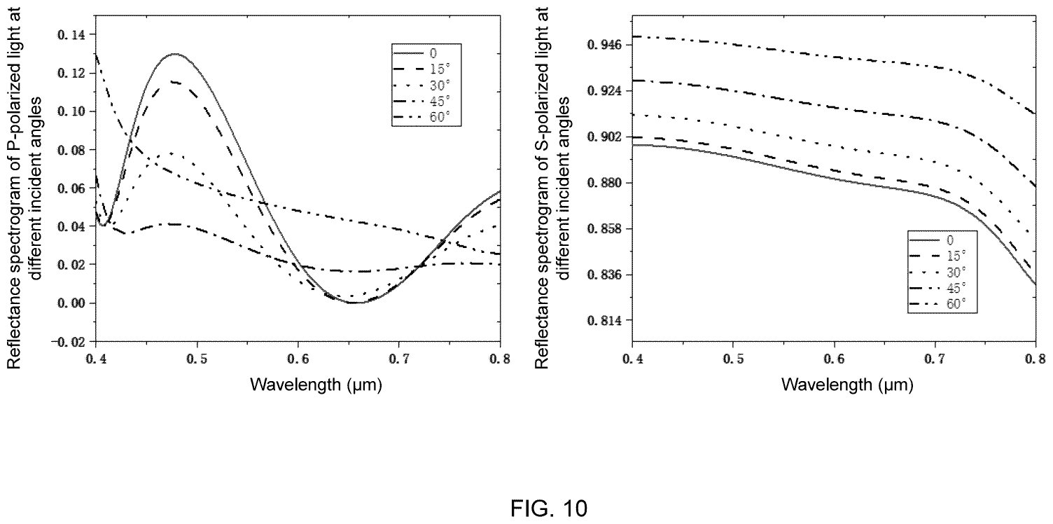

The polarizing film 200 of Example 1 is irradiated at different incident angles (0-60°), and reflectance spectrograms of the P-polarized light and the S-polarized light at different incident angles are obtained, as shown in FIG. 10. According to FIG. 10, if the incident angle varies from 0 to 60°, reflectance spectra of the P-polarized light and S-polarized light in a visible wavelength range are not much affected, which indicates that the polarizing film designed in the present disclosure has a relatively large angular tolerance, and the polarizing film is very suitable for the application scenarios with large angles.

The foregoing indicates that the polarizing film 200 of Example 1 is suitable for a wide range of incident angles.

### (4) Variation in the Refractive Index N1 of the Transparent Substrate

The polarizing film 200 of Examples 1-5 is introduced into the model for

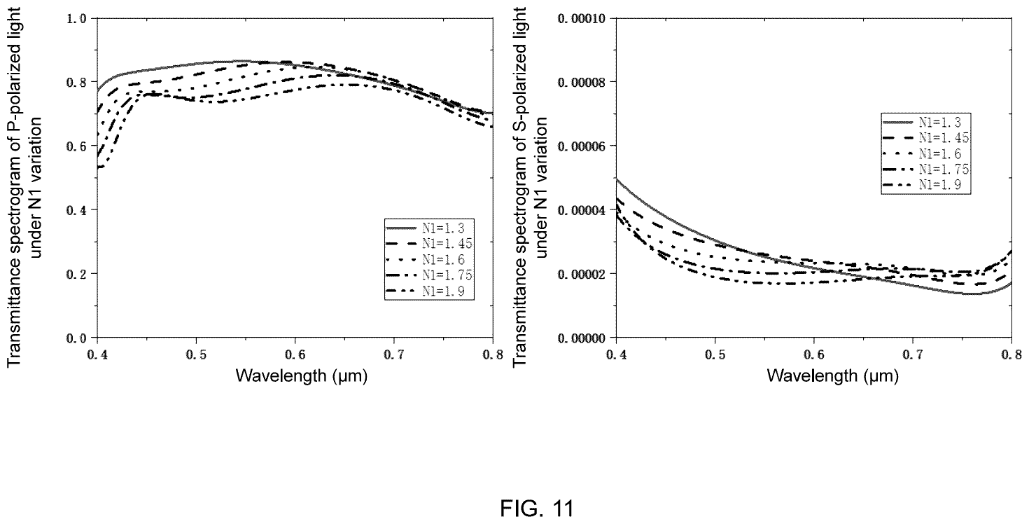

simulation, and transmittance spectra of the P-polarized light and the S-polarized at a 0° incident angle in a visible wavelength range are obtained, as shown in FIG. 11.

According to FIG. 11, if the refractive index N1 varies from 1.3 to 1.9, the transmittance spectra of the P-polarized light and S-polarized light in the visible wavelength range are not much affected.

### (5) Variation in the Refractive Index N2 of the Dielectric Grating

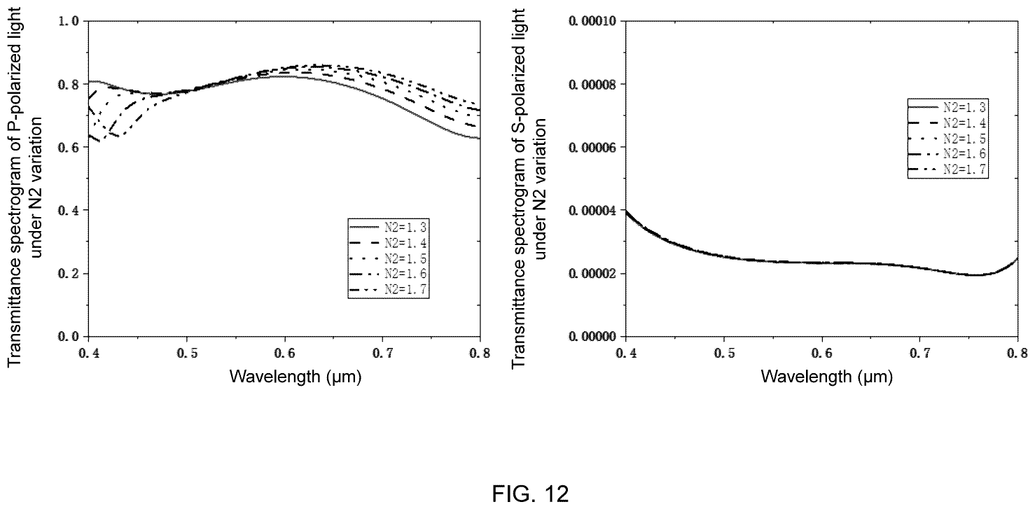

The polarizing film 200 of Example 1 and Examples 6-9 is introduced into the model for simulation, and transmittance spectra of the P-polarized light and the S-polarized at the 0° incident angle in the visible wavelength range are obtained, as shown in FIG. 12. According to FIG. 12, if the refractive index N2 varies from 1.3 to 1.7, the transmittance of the P-polarized light in the visible wavelength range does not have much effect on the spectrum, and the transmittance of the S-polarized light in the visible wavelength range is basically constant as the refractive index increases.

### (6) Variation in the Period p of the Dielectric Grating

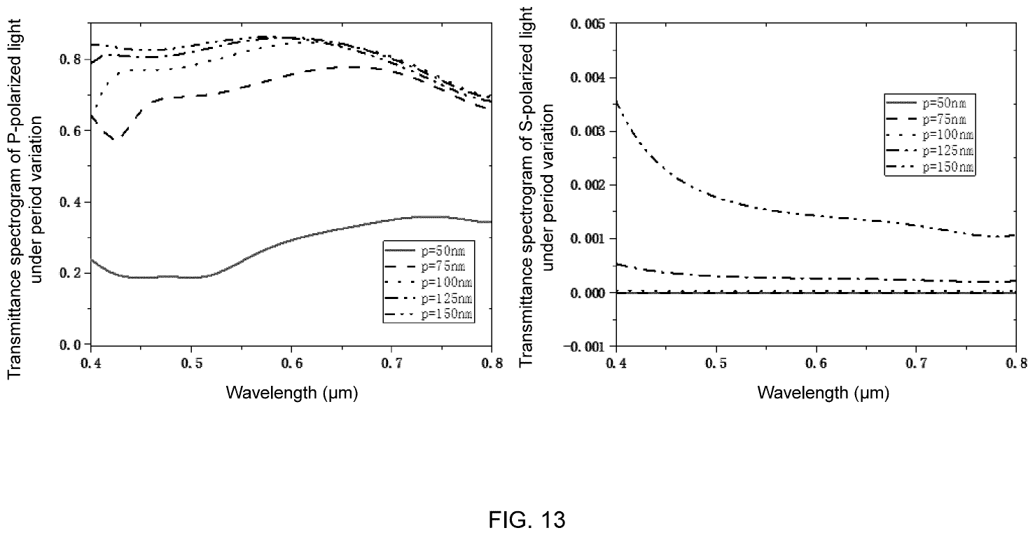

The polarizing film 200 of Example 1 and Examples 10-13 is introduced into the model for simulation, and transmittance spectra of the P-polarized light and the S-polarized at the 0° incident angle in the visible wavelength range are obtained, as shown in FIG. 13. According to FIG. 13, if the period p varies from 50 nm to 150 nm, the transmittance of the P-polarized light in the visible wavelength range is extremely low when the period is 50 nm, and the transmittance of the P-polarized light in the visible wavelength range increases sharply when the period is greater than 50 nm; and the transmittance of the S-polarized light in the visible wavelength range varies little with the increase of the period p.

### (7) Variation in the Duty Ratio f of the Dielectric Grating

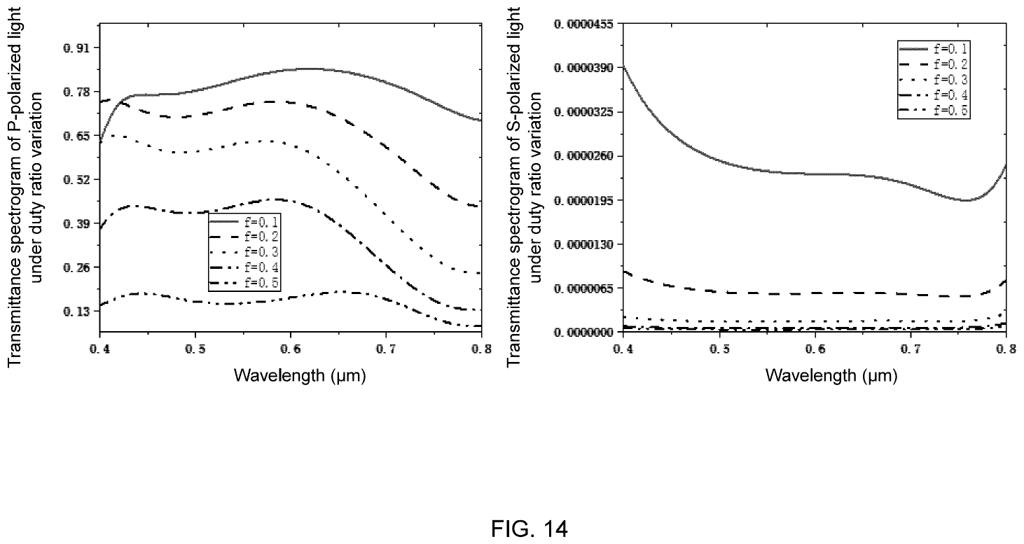

The polarizing film 200 of Example 1 and Examples 14-17 is introduced into the model for simulation, and transmittance spectra of the P-polarized light and the S-polarized at the 0° incident angle in the visible wavelength range are obtained, as shown in FIG. 14. According to FIG. 14, the transmittance of the P-polarized light in the visible wavelength range gradually decreases when the duty ratio f varies from 0.1 to 0.5; and the transmittance of the S-polarized light in the visible wavelength range decreases with the increase of the duty ratio f.

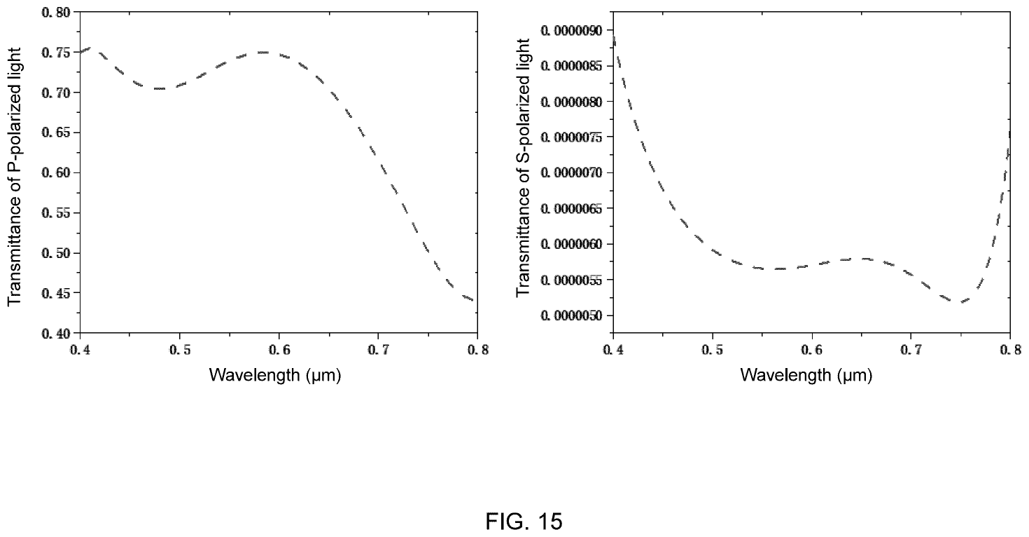

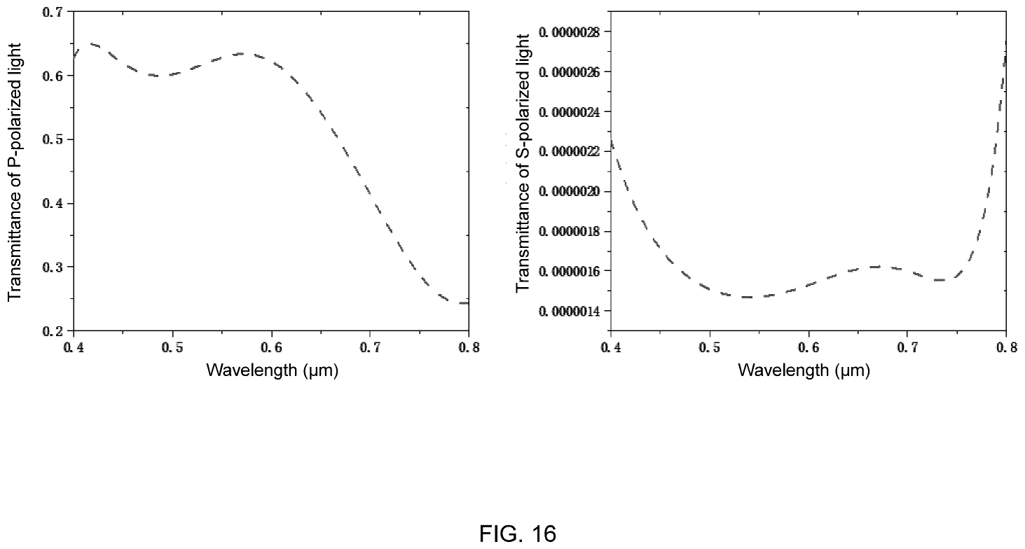

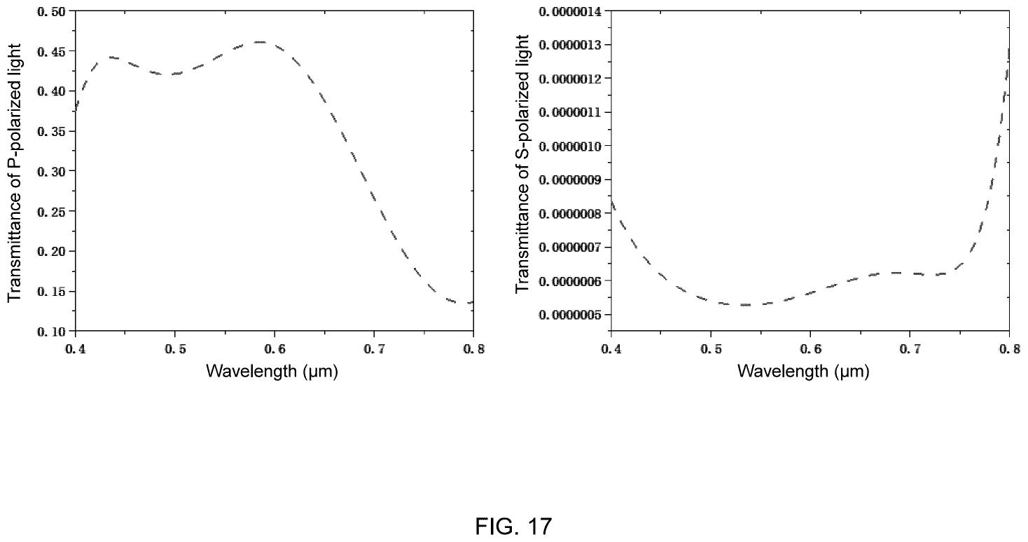

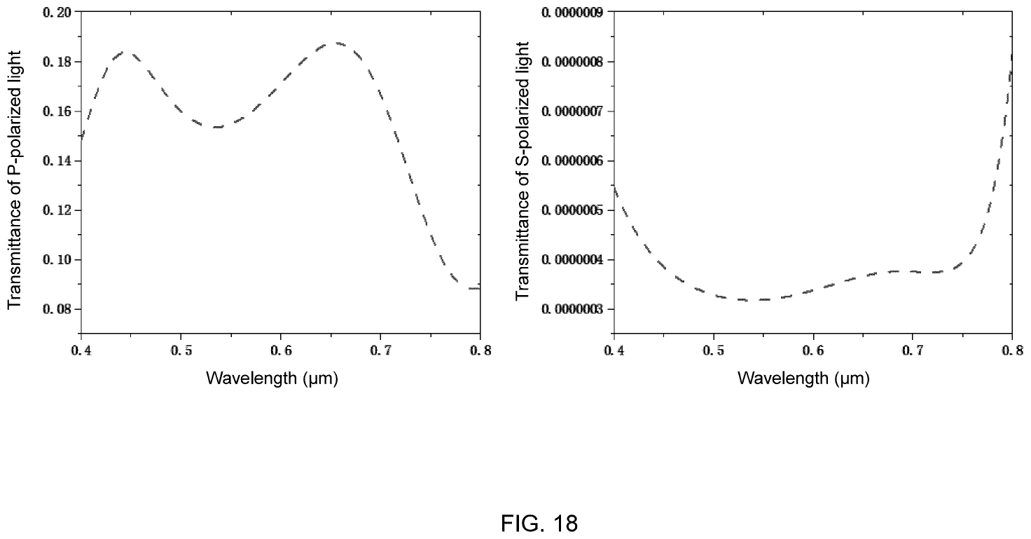

The polarizing film 200 of Examples 14-17 is introduced into the model for simulation to calculate the transmittances of the P-polarized light and the S-polarized light at normal incidence, as shown in FIGS. 15-18. According to FIGS. 15-18, the average transmittance of the P-polarized light is relatively high in a range of 400 nm-800 nm band; and the average transmittance of the S-polarized light is relatively low in the range of 400 nm-800 nm, which indicates that the polarizing film 200 of Examples 14-17 has a relatively low absorption loss.

Tp and Tc of the polarizing film 200 of Examples 14-17 at wavelengths of 450 nm, 550 nm, and 650 nm, and the calculated values of extinction ratios are shown in Table 3. According to the data in Table 3, the polarizing film 200 of Examples 14 to 17 has a relatively high extinction ratio.

TABLE 3
Test data for the polarizing film 200 of Examples 14-17

| Example | Wavelength | 450 nm | | 550 nm | 650 nm | |
|---|---|---|---|---|---|---|
| Example 14 | Transmittance | 71.64% | | 73.91% | 70.39% | |
| | Tp | | | | | |
| | Transmittance | 0.00067% | | 0.00056% | 0.00057% | |
| | Tc | | | | | |
| | Extinction | 50.29 | dB | 51.20 dB | 50.91 | dB |
| | Ratio EXT | | | | | |
| Example 15 | Transmittance | 61.94% | | 62.83% | 54.18% | |
| | Tp | | | | | |
| | Transmittance | 0.00017% | | 0.00014% | 0.00016% | |
| | Tc | | | | | |
| | Extinction | 55.61 | dB | 56.52 dB | 55.29 | dB |
| | Ratio EXT | | | | | |
| Example 16 | Transmittance | 43.74% | | 44.71% | 38.74% | |
| | Tp | | | | | |
| | Transmittance | 0.00006% | | 0.00005% | 0.00006% | |
| | Tc | | | | | |
| | Extinction | 58.62 | dB | 59.51 dB | 58.1 | dB |
| | Ratio EXT | | | | | |
| Example 17 | Transmittance | 18.31% | | 15.47% | 18.72% | |
| | Tp | | | | | |
| | Transmittance | 0.00004% | | 0.00003% | 0.00003% | |
| | Tc | | | | | |
| | Extinction | 56.6 | dB | 57.12 dB | 57.95 | dB |
| | Ratio EXT | | | | | |

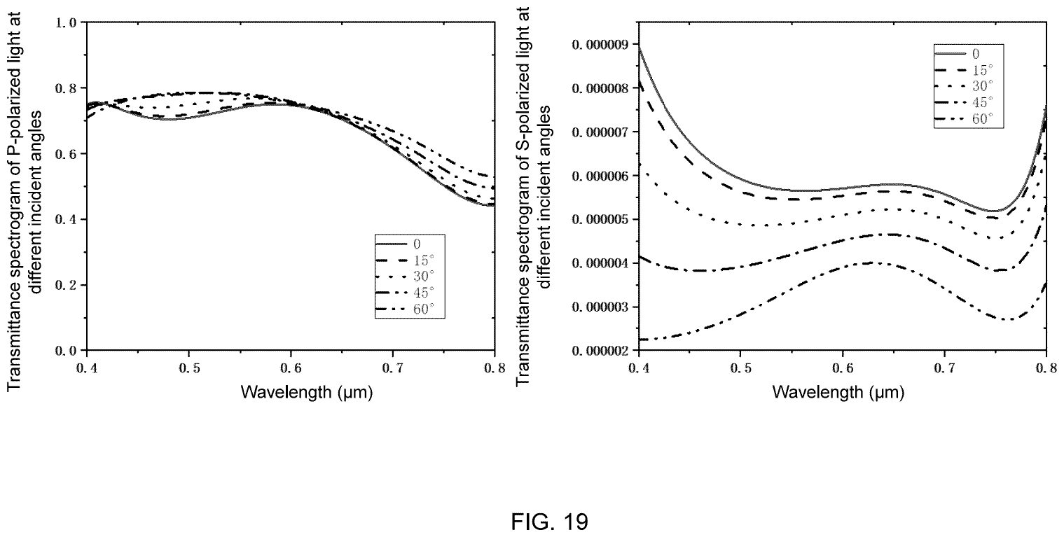

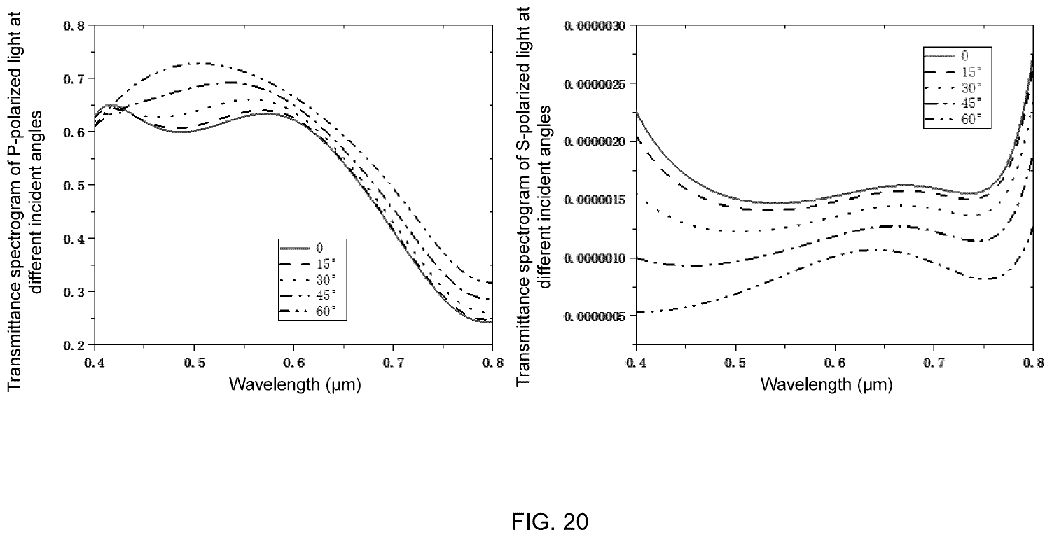

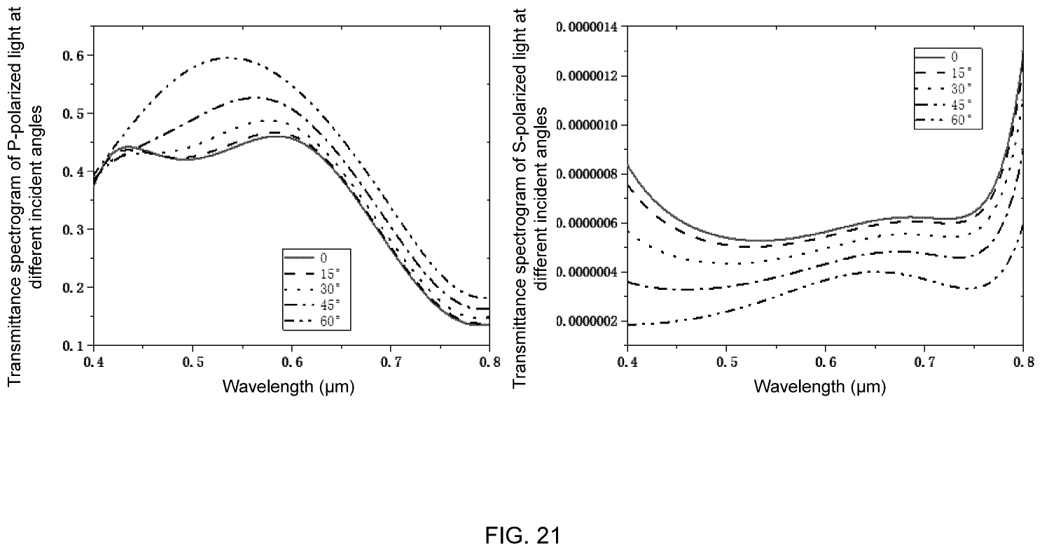

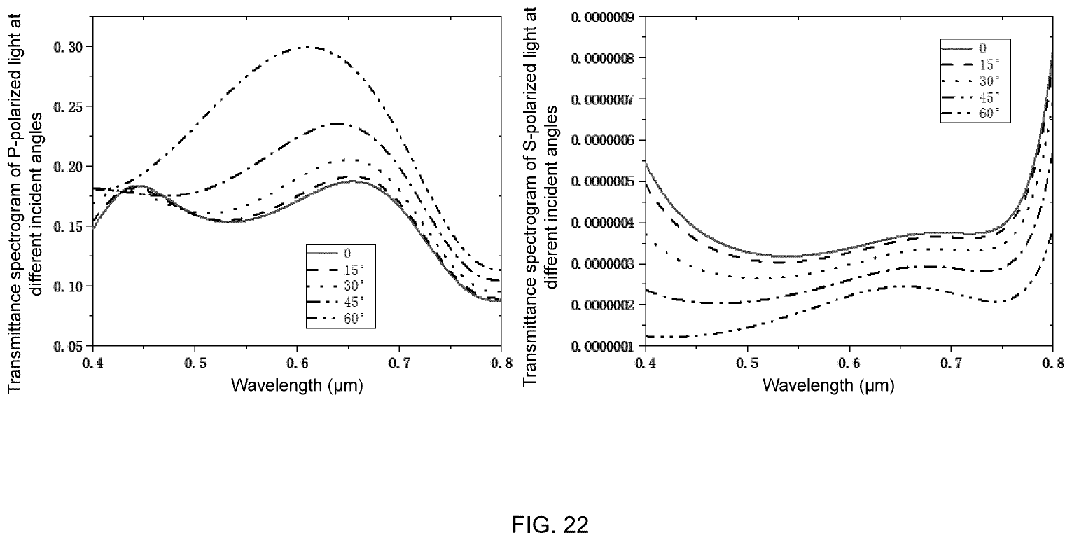

The polarizing film 200 of Examples 14-17 is irradiated at different incident angles (0-60°), and the transmittance spectrograms of the P-polarized light and the S-polarized light at different incident angles are obtained, as shown in FIGS. 19-22. According to FIGS. 19-22, if the incident angle varies from 0 to 60°, the transmittance spectra of the P-polarized light and the S-polarized light in the visible wavelength range are not much affected, which indicates that the polarizing film 200 of Examples 14-17 is suitable for wide incident angles.

### (8) Variation in the Ridge Thickness h1 of the Dielectric Grating

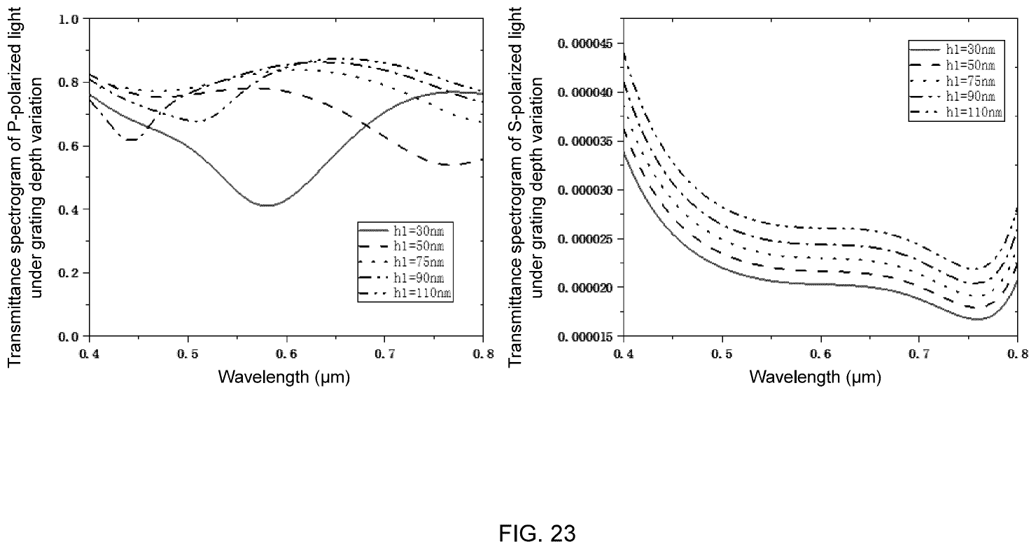

The polarizing film 200 of Example 1 and Examples 18-21 is introduced into the model for simulation to obtain the transmittance spectra of the P-polarized light and the S-polarized light at the 0° incident angle in the visible wavelength range, as shown in FIG. 23. According to FIG. 23, the transmittance of the P-polarized light in the visible wavelength range gradually increases when the thickness h1 of the ridges of the dielectric grating varies from 30 nm to 110 nm; and the transmittance of the S-polarized light in the visible wavelength range increases with the increase of the depth h1.

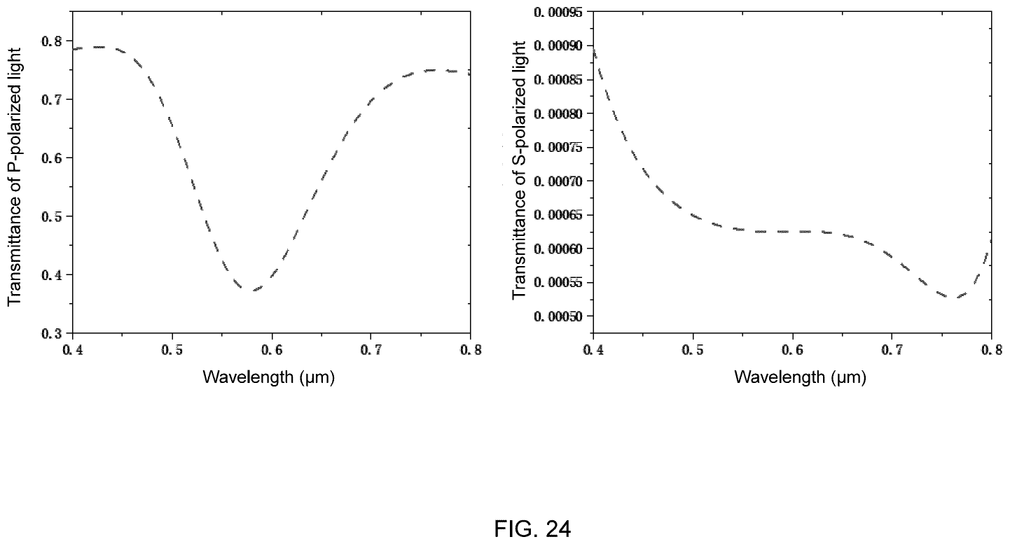

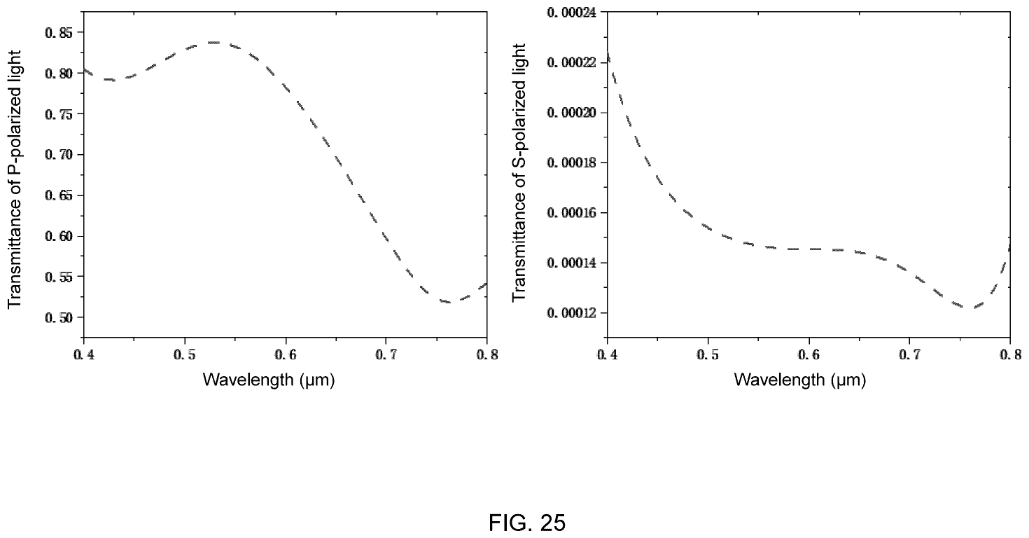

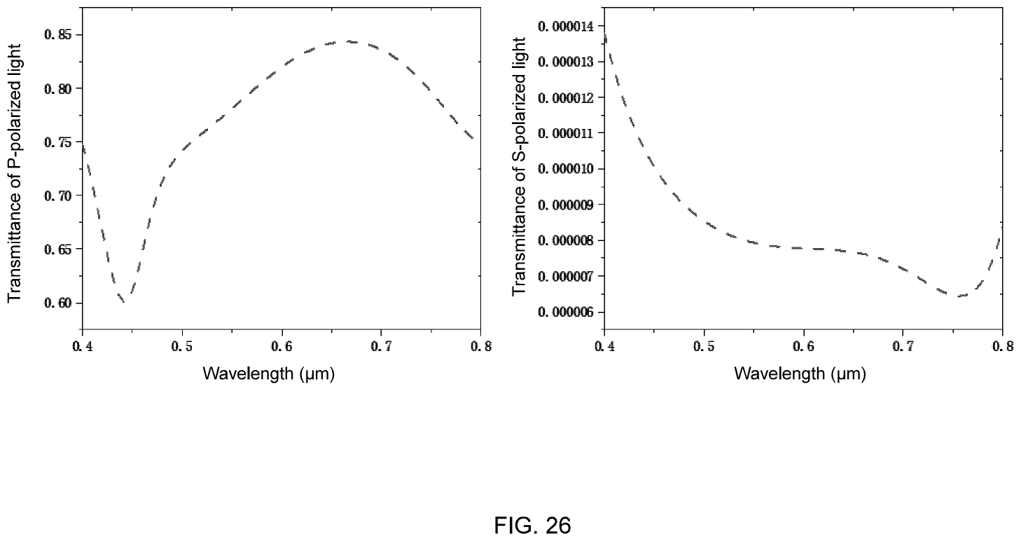

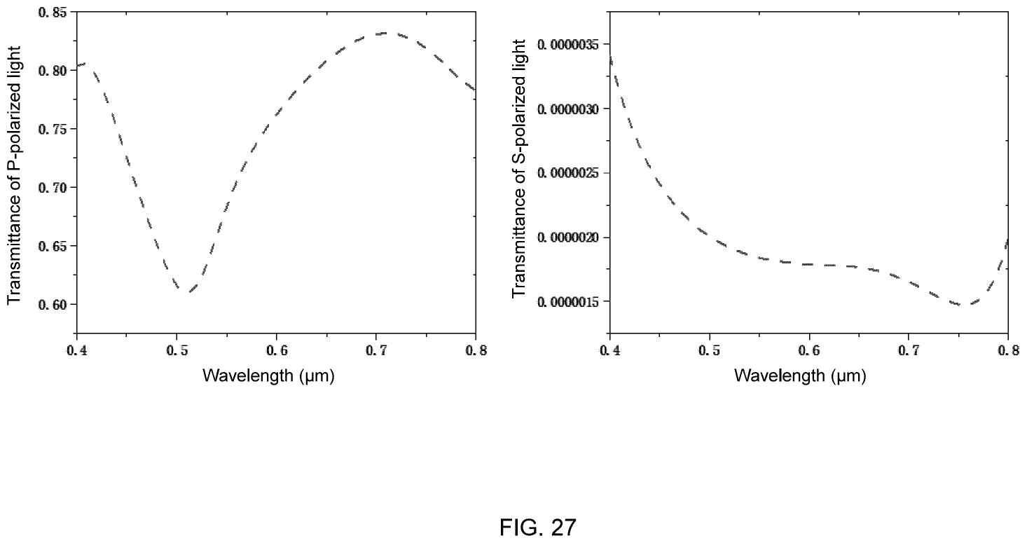

The polarizing film 200 of Examples 18-21 is introduced into the model for simulation to calculate the transmittance of the P-polarized light and the S-polarized light at normal incidence, as shown in FIGS. 24-27. According to FIGS. 24-27, the average transmittance of the P-polarized light is relatively high in the range of 400 nm-800 nm; the average transmittance of the S-polarized light is relatively low in the range of 400 nm-800 nm, which indicates that the polarizing film 200 of Examples 18-21 has a relatively low absorption loss.

Tp and Tc of the polarizing film 200 of Examples 18-21 at wavelengths of 450 nm, 550 nm, and 650 nm, and the calculated values of extinction ratios are shown in Table 4. According to the data in Table 4, the polarizing film 200 of Examples 18-21 has a relatively high extinction ratio.

TABLE 4
Test data for the polarizing film 200 of Examples 18-21

| Example | Wavelength | 450 nm | | 550 nm | | 650 nm |
|---|---|---|---|---|---|---|
| Example 18 | Transmittance | 78.22% | | 42.47% | | 56.22% |
| | Tp | | | | | |
| | Transmittance | 0.071% | | 0.062% | | 0.062% |
| | Tc | | | | | |
| | Extinction | 30.42 | dB | 28.35 | dB | 29.57 dB |
| | Ratio EXT | | | | | |
| Example 19 | Transmittance | 79.72% | | 83.26% | | 69.65% |
| | Tp | | | | | |
| | Transmittance | 0.017% | | 0.014% | | 0.014% |
| | Tc | | | | | |
| | Extinction | 36.71 | dB | 37.74 | dB | 36.97 dB |
| | Ratio EXT | | | | | |
| Example 20 | Transmittance | 61.04% | | 79.1% | | 84.23% |
| | Tp | | | | | |
| | Transmittance | 0.001% | | 0.00079% | | 0.00076% |
| | Tc | | | | | |
| | Extinction | 47.85 | dB | 50 | dB | 50.44 dB |
| | Ratio EXT | | | | | |
| Example 21 | Transmittance | 72.57% | | 68.34% | | 80.83% |
| | Tp | | | | | |
| | Transmittance | 0.00024% | | 0.00018% | | 0.00017% |
| | Tc | | | | | |
| | Extinction | 54.8 | dB | 55.79 | dB | 56.77 dB |
| | Ratio EXT | | | | | |

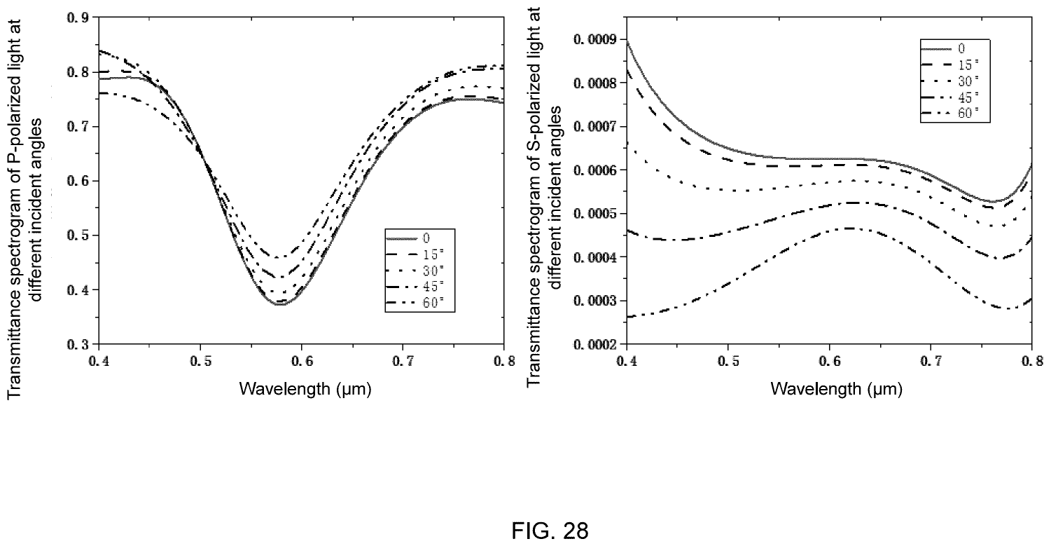

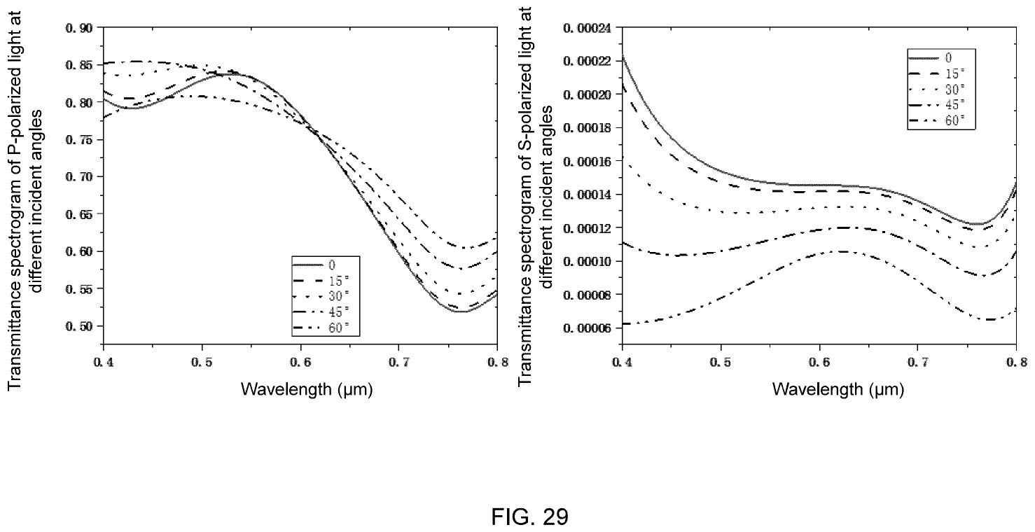

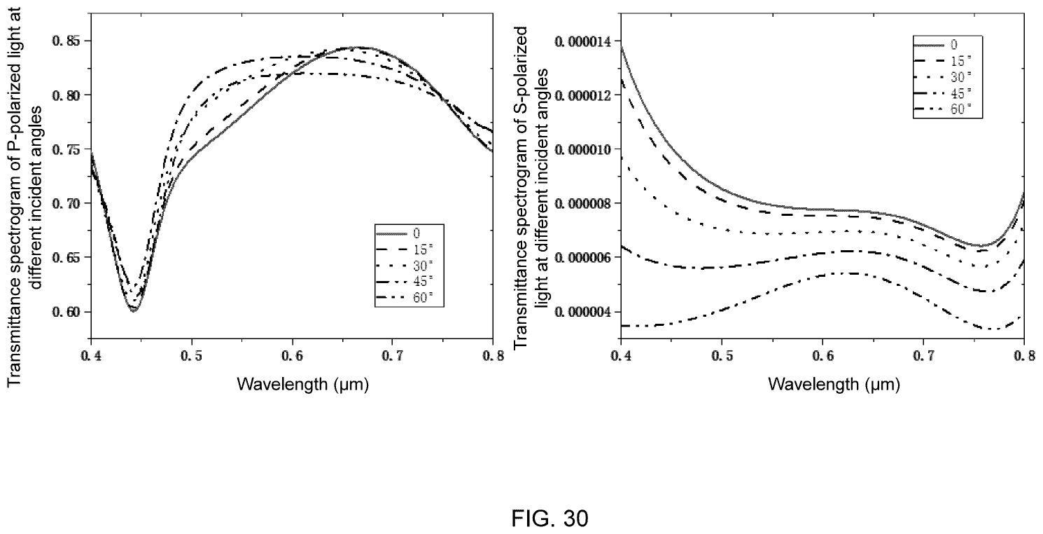

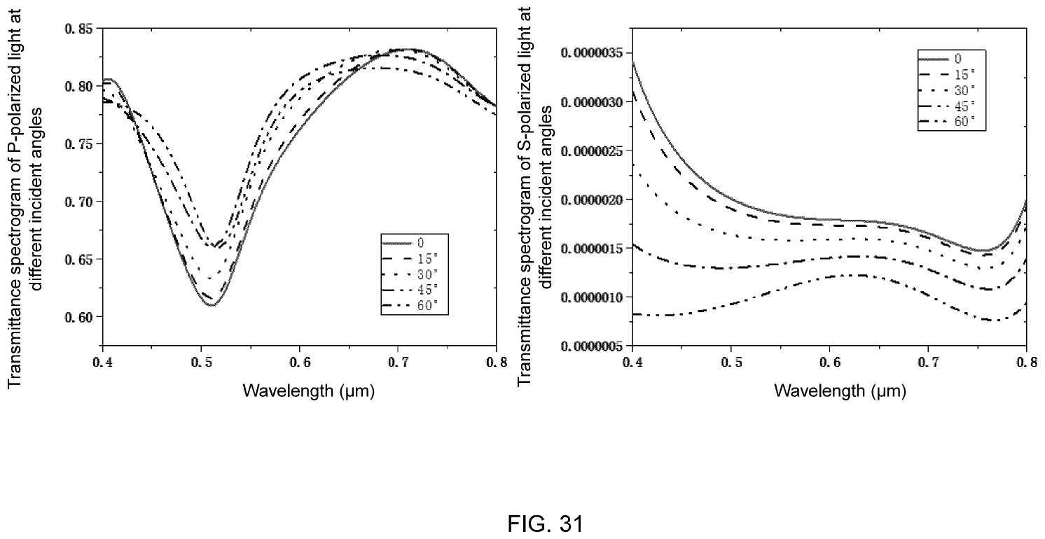

The polarizing film 200 of Examples 18-21 is irradiated at different incident angles (0-60°), and the transmittance spectra of the P-polarized light and the S-polarized light at different incident angles are obtained, as shown in FIGS. 28-31. According to FIGS. 28-31, if the incident angle varies from 0 to 60°, the transmittance spectra of the P-polarized light and the S-polarized light in the visible wavelength range are not much affected, which indicates that the polarizing film 200 of Examples 18-21 is suitable for wide incident angles.

### (9) Variation in the Thickness h2 of the Metallic Layer of the Dielectric Grating

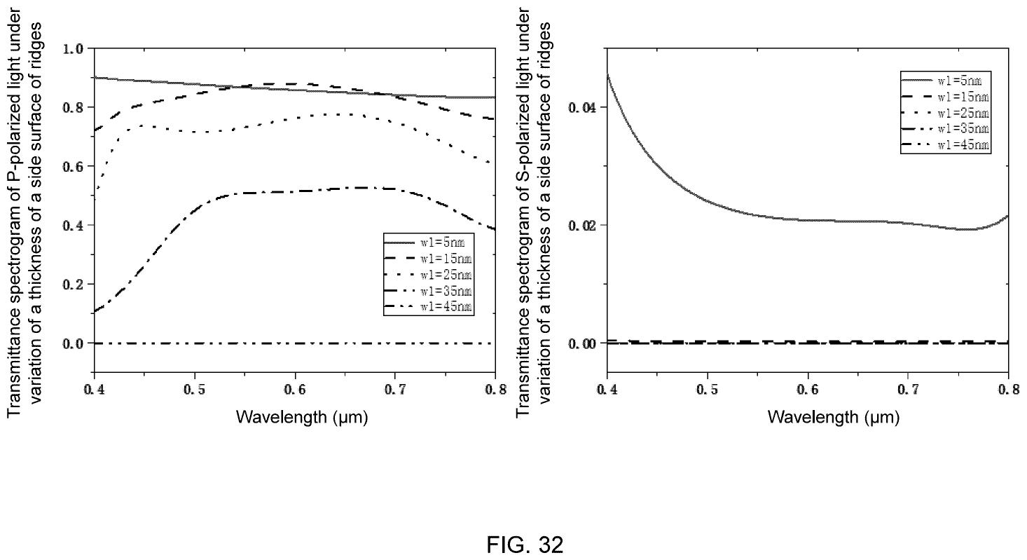

The polarizing film 200 of Example 1 and Examples 22-26 is introduced into the model for simulation to obtain the transmittance spectra of the P-polarized light and the S-polarized light at the 0° incident angle in the visible wavelength range, as shown in FIG. 32. According to FIG. 32, if the thickness w1 of a portion of the metallic layer of the dielectric grating located on the side surface of the ridges varies from 5 nm to 45 nm, the transmittance of the P-polarized light in the visible wavelength range varies sharps, and tends to a high value at a thickness of 5 nm; the transmittance of the S-polarized light in the visible wavelength range decreases sharply with the increase of the thickness w1 of the portion of the metallic layer of the dielectric grating located on the side surface of the ridges.

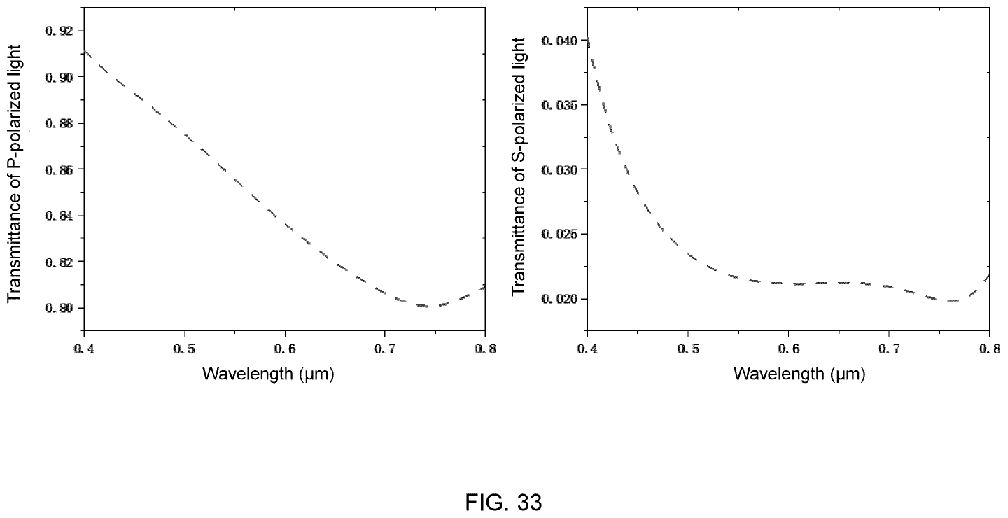

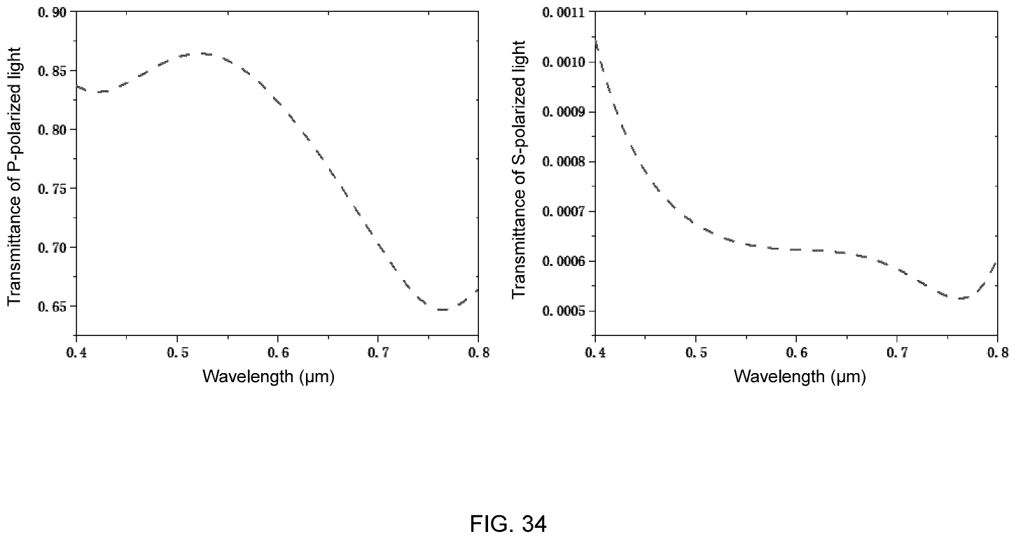

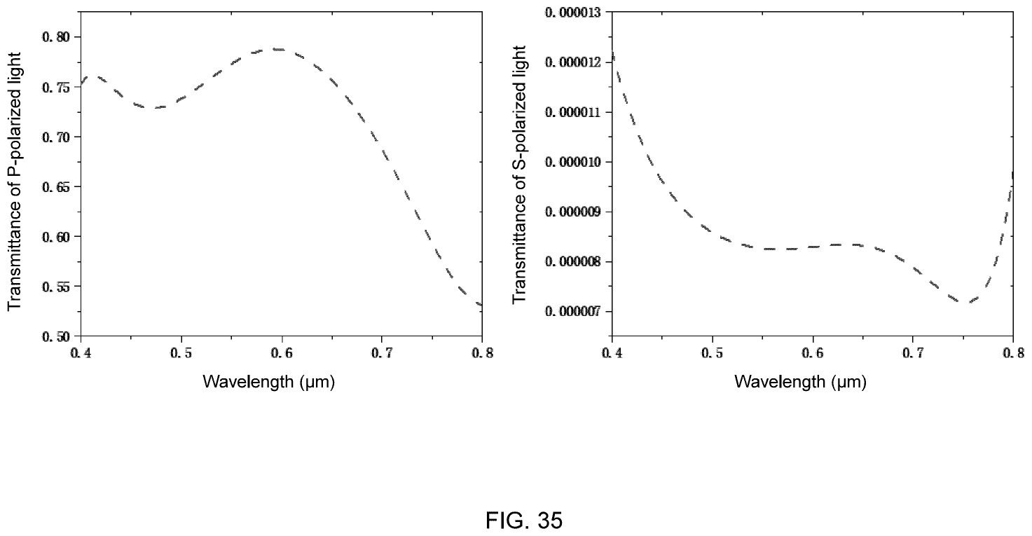

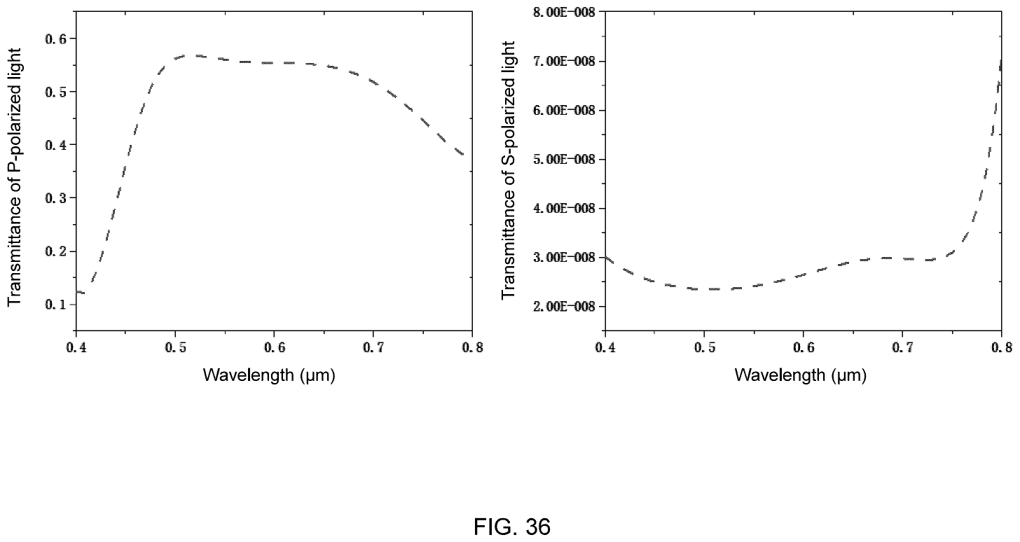

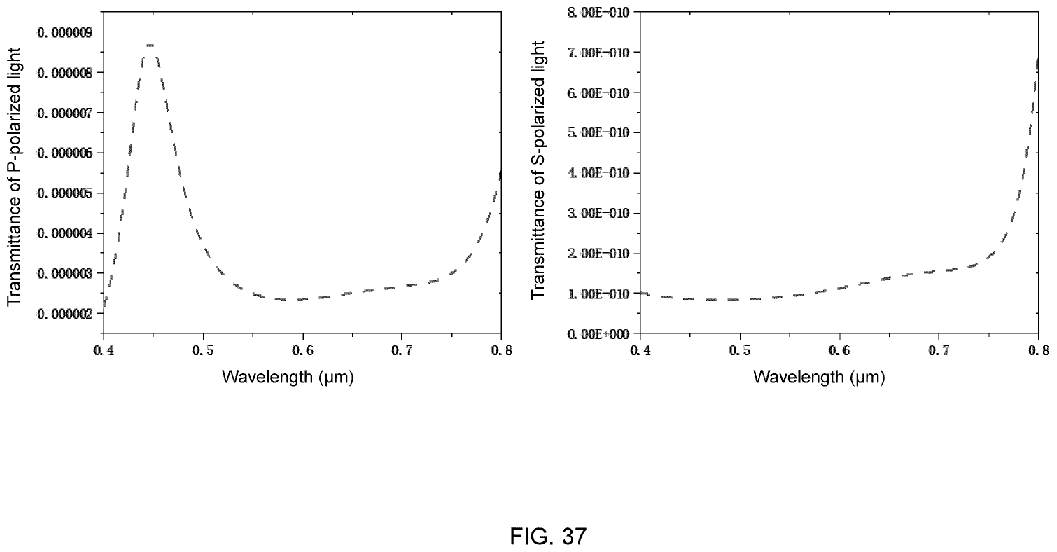

The polarizing film 200 of Examples 22-26 is introduced into the model for simulation to calculate the transmittances of the P-polarized light and S-polarized light at normal incidence, as shown in FIGS. 33-37. According to FIGS. 33-37, the average transmittance of the P-polarized light is relatively high in the range of 400 nm-800 nm; the average transmittance of the S-polarized light is relatively low in the range of 400 nm-800 nm, which indicates that the polarizing film 200 of Examples 22-26 has a relatively low absorption loss.

Tp and Tc of the polarizing films 200 of Examples 22-26 at wavelengths of 450 nm, 550 nm, and 650 nm, and the calculated values of extinction ratios are shown in Table 5. According to the data in Table 5, the polarizing film 200 of Examples 22-26 has a relatively high extinction ratio.

TABLE 5
Test data for the polarizing film 200 of Examples 22-26

| Example | Wavelength | 450 nm | | 550 nm | 650 nm | |
|---|---|---|---|---|---|---|
| Example | Transmittance | 89.28% | | 85.56% | 81.96% | |
| 22 | Tp | | | | | |
| | Transmittance | 2.79% | | 2.16% | 2.12% | |
| | Tc | | | | | |
| | Extinction | 15 | dB | 15.98 dB | 15.87 | dB |
| | Ratio EXT | | | | | |
| Example | Transmittance | 83.95% | | 85.9% | 76.82% | |
| 23 | Tp | | | | | |
| | Transmittance | 0.077% | | 0.063% | 0.061% | |
| | Tc | | | | | |
| | Extinction | 30.37 | dB | 31.34 dB | 31 | dB |
| | Ratio EXT | | | | | |
| Example | Transmittance | 73.47% | | 77.91% | 75.59% | |
| 24 | Tp | | | | | |
| | Transmittance | 0.00096% | | 0.00082% | 0.00083% | |
| | Tc | | | | | |
| | Extinction | 48.83 | dB | 49.77 dB | 49.59 | dB |
| | Ratio EXT | | | | | |
| Example | Transmittance | 36.12% | | 56% | 54.89% | |
| 25 | Tp | | | | | |
| | Transmittance | 0.000002% | | 0.000002% | 0.000003% | |
| | Tc | | | | | |
| | Extinction | 56.6 | dB | 57.12 dB | 57.95 | dB |
| | Ratio EXT | | | | | |
| Example | Transmittance | 0.00086% | | 0.00025% | 0.00025% | |
| 26 | Tp | | | | | |
| | Transmittance | 8.7*10⁻¹¹ | | 9.4*10⁻¹¹ | 13.9*10⁻¹¹ | |
| | Tc | | | | | |
| | Extinction | 49.94 | dB | 44.24 dB | 42.55 | dB |
| | Ratio EXT | | | | | |

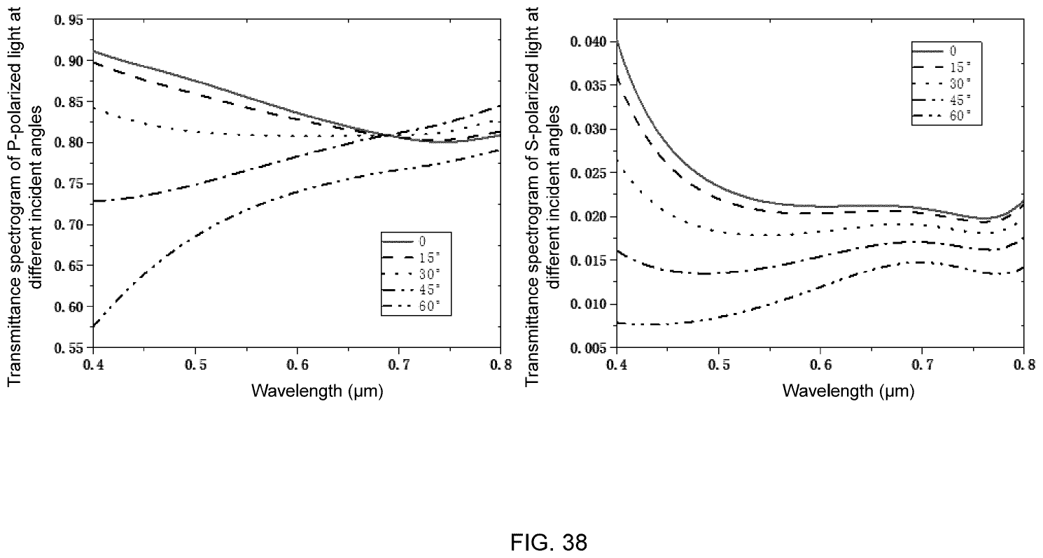

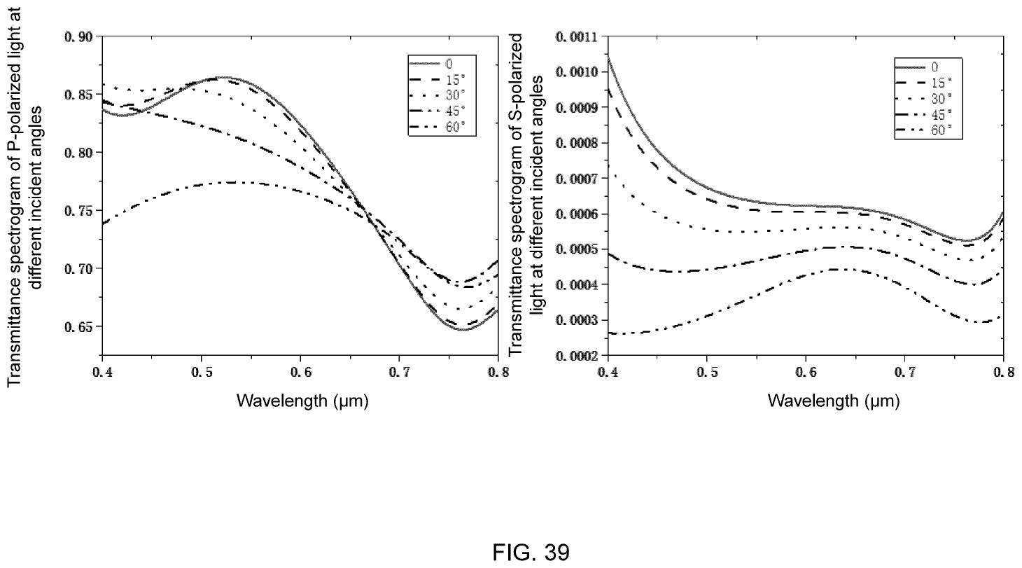

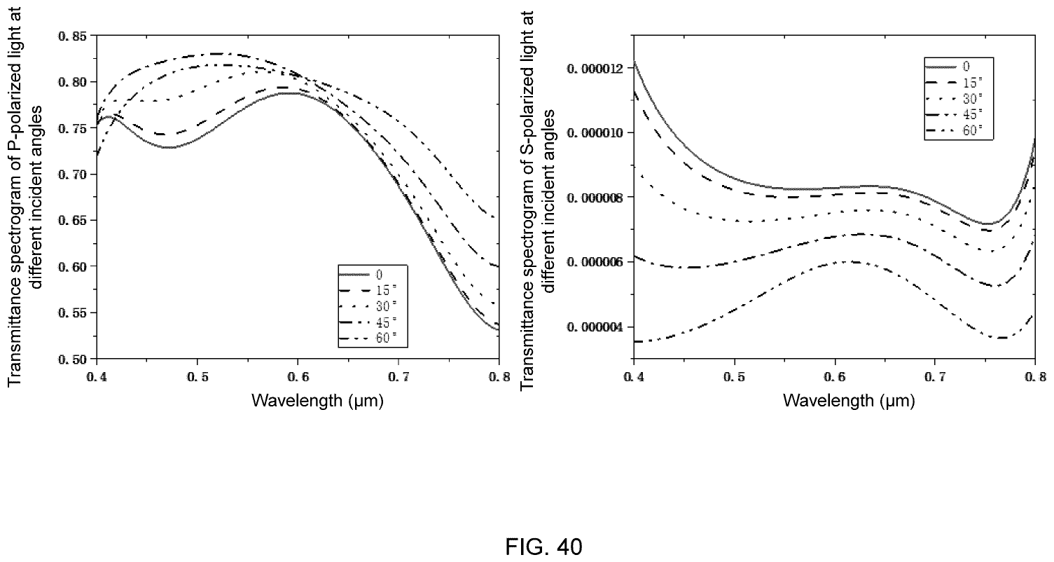

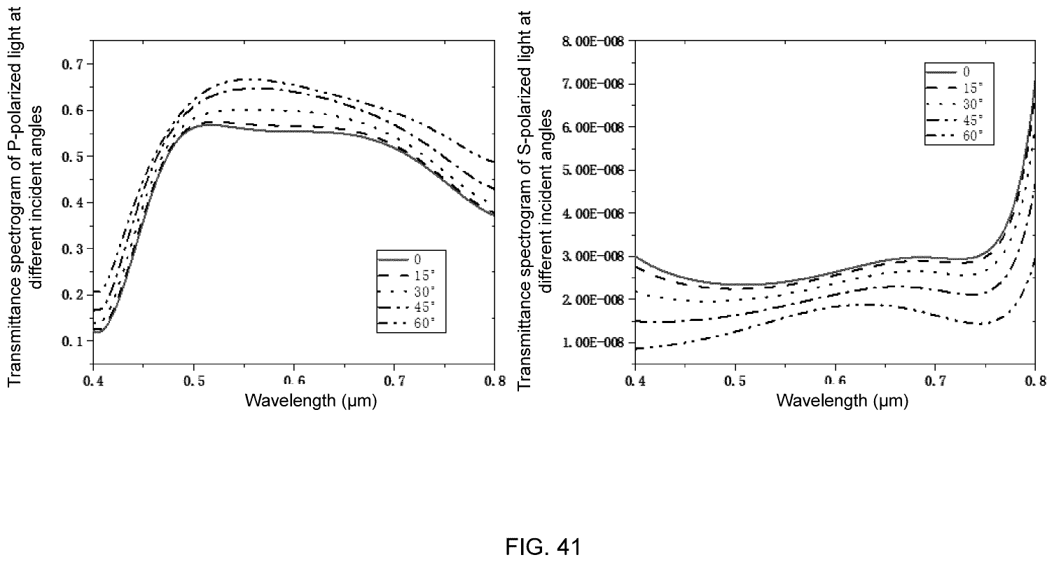

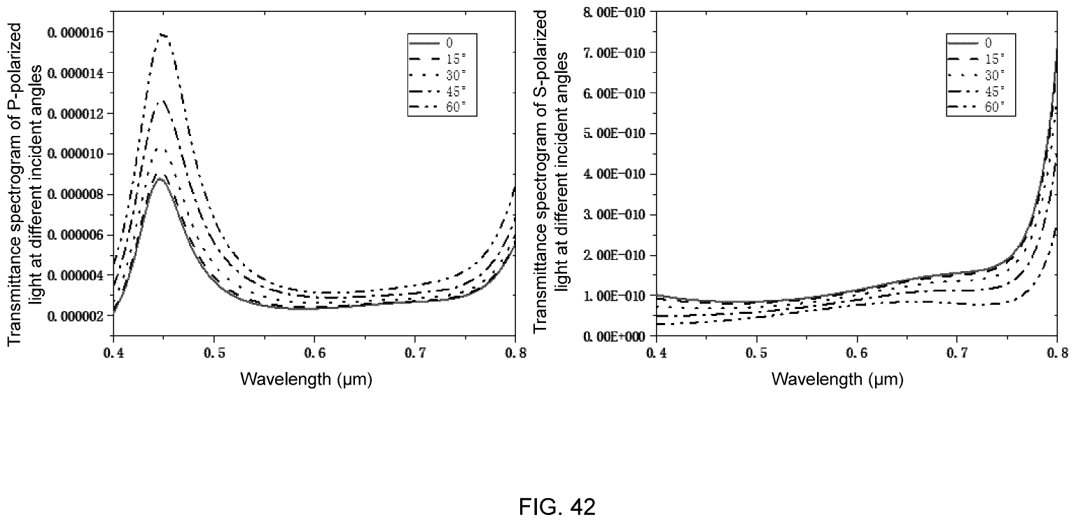

The polarizing film 200 of Examples 22-26 is irradiated at different incident angles (0-60°), and transmittance spectra of the P-polarized light and the S-polarized light at different incident angles are obtained, as shown in FIGS. 38-42. According to FIGS. 38-42, if the incident angle varies from 0 to 60°, the transmittance spectra of the P-polarized light and the S-polarized light in the visible wavelength range are not much affected, which indicates that the polarizing film 200 of Examples 22-26 is suitable for wide incident angles.

### Performance Testing (Example 27)

### (1) Transmittance

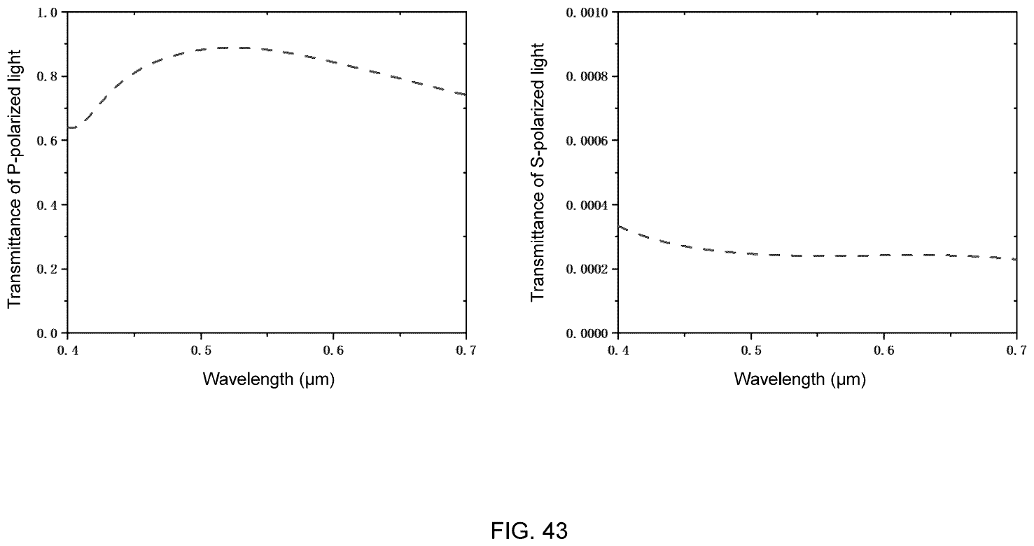

The polarizing film 100 of Example 27 is introduced into the 3D structural model and subjected to parameter calibration, and then the transmittances of the P-polarized light and the S-polarized light at normal incidence are calculated by simulated based on RCWA, as shown in FIG. 43. According to FIG. 43, the transmittance of the P-polarized light in a range of 400 nm-700 nm is 80% on average, with a maximum of 88%; the transmittance of the S-polarized light in the range of 400 nm-700 nm is 0.03% on average.

By calculating Tp and Tc of the polarizing film 100 of Example 27 at the wavelengths of 450 nm, 550 nm, and 650 nm, the corresponding values of extinction ratios are calculated, as shown in Table 6. According to the data in Table 6, the extinction ratio of the polarizing film 100 of Example 27 is 35.28 dB at the wavelength of 450 nm, 35.65 dB at the wavelength of 550 nm, and 35.18 dB at the wavelength of 650 nm. The foregoing indicates that the polarizing film 100 of Example 27 has a relatively low absorption loss and a relatively high extinction ratio.

TABLE 6
Test data for the polarizing film 100 of Example 27

| Wavelength | 450 nm | 550 nm | 650 nm |
|---|---|---|---|
| Transmittance Tp | 81.04% | 88.18% | 79.23% |
| Transmittance Tc | 0.024% | 0.024% | 0.024% |
| Extinction Ratio | 35.28 dB | 35.65 dB | 35.18 dB |
| EXT | | | |

### (2) Reflectance

The polarizing film 100 of Example 27 is into the model for simulation to calculate the reflectances of the P-polarized light and the S-polarized light, as shown in

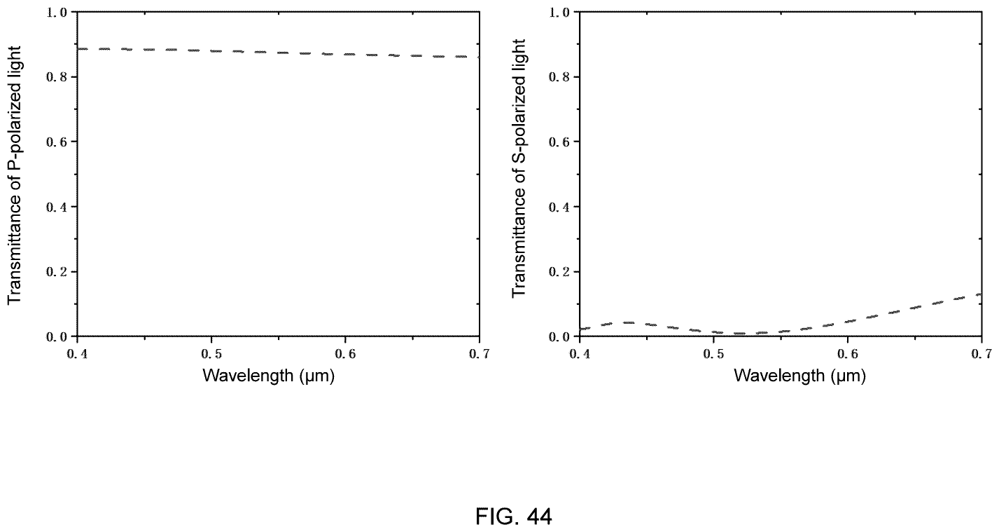

FIG. 44. According to FIG. 44, the reflectance of the P-polarized light in the range of 400 nm-700 nm is 2% on average; and the reflectance of the S-polarized light in the range of 400 nm-700 nm is 88% on average. The foregoing indicates that the polarizing film 100 of Example 27 has a relatively low absorption loss and a relatively high extinction ratio.

### (3) Incident Angle

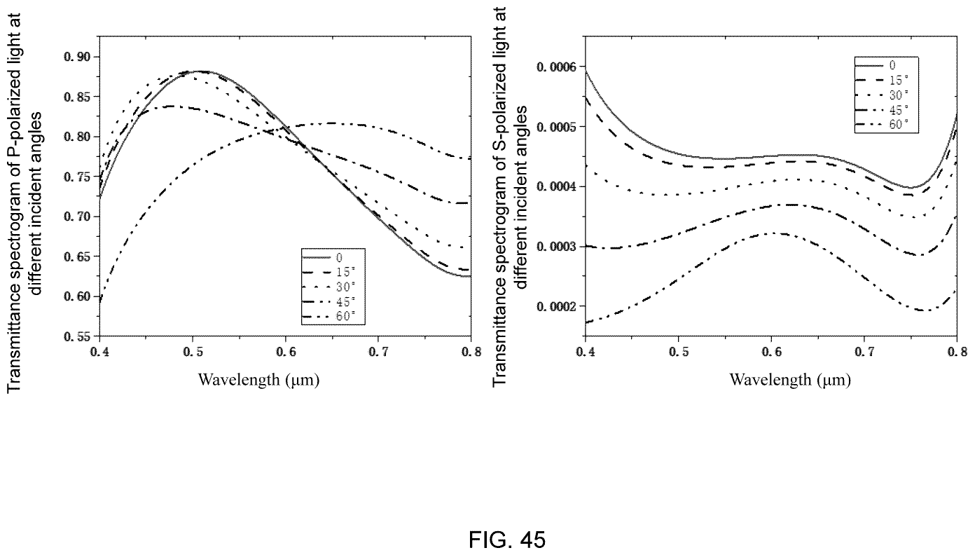

The polarizing film 100 of Example 27 is irradiated at different incident angles (0-60°), and the transmittance spectra of the P-polarized light and the S-polarized light at different incident angles are obtained, as shown in FIG. 45. According to FIG. 45, if the incident angle varies from 0-60°, the transmittance spectra of the P-polarized light and the S-polarized light in the visible wavelength range are not much affected, which indicates that the polarizing film 100 of Example 27 is suitable for wide incident angles.

The technical features of the above embodiments can be combined arbitrarily. In order to make the description concise, not all possible combinations of the technical features in the above embodiments are described. However, to the extent that there is no contradiction in the combination of these technical features, they should be considered to be within the scope of the present disclosure.

The above embodiments only express several embodiments of the present disclosure, and the description is relatively specific and detailed, but it cannot be understood as limiting the scope of the present disclosure. It should be noted that for those having ordinary skills in the art, some variations and improvements can also be made without departing from the concept of the present disclosure, which are within the protection scope of the present disclosure. Therefore, the protection scope of the present disclosure shall be based on the attached claims.

What is claimed is:

1. A polarizing film, comprising:
a transparent substrate;
a dielectric grating disposed on the transparent substrate and provided with ridges and grooves which are periodically arrange at intervals; and
a metallic layer configured to cover a top surface and a side surface of each of the ridges of the dielectric grating to cause at least a portion of a bottom of each of the grooves of the dielectric grating to be exposed.

2. The polarizing film of claim 1, wherein a period of the dielectric grating is in a range of 50 nm-150 nm, a duty ratio of the dielectric grating is in a range of 0.1-0.5, a thickness of each of the ridges of the dielectric grating is in a range of 30 nm-110 nm, a thickness of a portion of the metallic layer located on the top surface of each of the ridges of the dielectric grating is in a range of 30 nm-150 nm, and a thickness of a portion of the metallic layer located on the side surface of each of the ridges of the dielectric grating is in a range of 5 nm-50 nm.

3. The polarizing film of claim 1, wherein a refractive index of the transparent substrate is in a range of 1.3-1.9, and a refractive index of the dielectric grating is in a range of 1.3-1.7.

4. The polarizing film of claim 1, wherein a width of a portion of the metallic layer located on the bottom of each of the grooves of the dielectric grating is in a range of 0 nm-50 nm, and a thickness of the portion of the metallic layer located on the bottom of each of the grooves of the dielectric grating is in a range of 0 nm-50 nm.

5. The polarizing film of claim 1, wherein the bottom of each of the grooves of the dielectric grating is completely exposed out of the metallic layer.

6. The polarizing film of claim 1, wherein a material of the metallic layer is at least one of gold, silver, copper, aluminum, and tungsten.

7. The polarizing film of claim 1, wherein a material of the dielectric grating is a resin-based curing adhesive.

8. The polarizing film of claim 1, wherein the transparent substrate is a flexible substrate.

9. The polarizing film of claim 8, wherein a material of the flexible substrate is at least one of polycarbonate, polyvinyl chloride, polyethylene terephthalate, polymethylmethacrylate, polypropylene, and cellulose triacetate.

10. The polarizing film of claim 1, further comprising a protective layer, wherein the protective layer covers the transparent substrate, the dielectric grating, and the metallic layer.

11. The polarizing film of claim 10, wherein a refractive index of the protective layer is in a range of 1.3-1.7, and a distance between a surface of the protective layer away from the transparent substrate and the metallic layer is in a range of 0 nm-300 nm.

12. The polarizing film of claim 10, wherein a material of the protective layer is at least one of SiO₂, MgF₂, and SiON.

13. A manufacturing method of a polarizing film, comprising:
forming a dielectric grating on a transparent substrate, the dielectric grating being provided with ridges and grooves which are periodically arranged at intervals; and
forming a metallic layer on the dielectric grating, the metallic layer being configured to cover a top surface and a side surface of each of the ridges of the dielectric grating to cause at least a portion of a bottom of each of the grooves of the dielectric grating to be exposed, so as to obtain the polarizing film.

14. The manufacturing method of claim 13, wherein the forming a dielectric grating on a transparent substrate includes:
attaching the transparent substrate to an imprinting template, an imprinting adhesive being coated between the transparent substrate and the imprinting template, then pressing the transparent substrate and the imprinting template, and demolding the imprinting template from the imprinting adhesive after the imprinting adhesive is cured to form the dielectric grating on the transparent substrate.

15. The manufacturing method of claim 13, wherein the forming a metallic layer on the dielectric grating includes:
forming the metallic layer on the dielectric grating by a plating process, wherein aluminum (Al) is plated, a plating thickness is in a range of 5 nm-200 nm, a plating rate is in a range of 0.1 Å/S-10 Å/S, an evaporation power is in a range of 0-60%, an operation vacuum level is in a range of 1E-6 Torr-10E-6 Torr, and a temperature is in a range of 25° C.-35° C.

16. An optical waveguide lens, comprising:
an optical waveguide provided with a light receiving surface for receiving light and a backlight surface disposed on an opposite side of the light receiving surface; and
the polarizing film of claim 1 disposed on the backlight surface of the optical waveguide, the transparent substrate of the polarizing film being disposed away from the optical waveguide; wherein
a gap is provided between the optical waveguide and the polarizing film.

17. The optical waveguide lens of claim 16, wherein a transmittance of the polarizing film to S-polarized light is less than 5%, and a transmittance of the polarizing film to P-polarized light is greater than or equal to 60%;
the polarizing film is fixed to the optical waveguide through a bonding adhesive, the bonding adhesive being disposed at an edge position of the polarizing film and the optical waveguide.

18. The optical waveguide lens of claim 16, wherein a distance between the optical waveguide and the polarizing film is in a range of 1 μm-5 cm.

19. The optical waveguide lens of claim 16, further comprising a rigid substrate configured to support the polarizing film, wherein the rigid substrate fits a side of the polarizing film away from the optical waveguide.
